(19) United States
(12) Patent Application Publication
(10) Pub. No.: US 2024/0351031 A1
(43) Pub. Date: Oct. 24, 2024

(54) Xanthommatin-Based Light Sensors

(71) Applicant: Northeastern University, Boston, MA (US)

(72) Inventors: Daniel Wilson, Medford, MA (US); Leila Deravi, Cambridge, MA (US)

(21) Appl. No.: 18/685,957

(22) PCT Filed: Aug. 23, 2022
(86) PCT No.: PCT/US2022/075314

§ 371 Date: Feb. 23, 2024

Related U.S. Application Data
(60) Provisional application No. 63/236,231, filed on Aug. 23, 2021.

(51) Int. Cl. B01L 3/00

(52) U.S. Cl. CPC B01L 3/502715; B01L 2300/0663; B01L 2300/0832; B01L 2300/168

(57) ABSTRACT

Described herein is a sensor comprising a porous substrate comprising xanthommatin or a salt or a crosslinked derivative thereof. The sensor can be fabricated by distributing xanthommatin or a salt thereof throughout the porous substrate, and optionally crosslinking the distributed xanthommatin or a salt thereof. The sensors can be incorporated into microfluidic devices and/or used as wearable or mountable solar radiometers and/or UVC radiation detectors.

### RELATED APPLICATION

This application claims the benefit of U.S. Provisional Application No. 63/236,231, filed on Aug. 23, 2021. The entire teachings of the above application are incorporated herein by reference.

### GOVERNMENT SUPPORT

This invention was made with government support under Grant No. W911NF-19-2-0204 from the Army Research Office and Grant No. W911QY-19-9-0011 from the U.S. Army Combat Capabilities Development Command Soldier Center. The government has certain rights in the invention.

### BACKGROUND

The harmful effects of overexposure to ultraviolet (UV) radiation from solar light have highlighted the importance of managing both short-term and cumulative exposure to the sun as a means of protection against skin and eye damage. Skin erythema, more commonly known as sunburning, is primarily attributed to cellular DNA damage caused by UVB radiation (280-315 nm), which represents only a small portion of total solar irradiance. Longer ultraviolet wavelengths in the UVA range (315-400 nm) penetrate deeper into the skin than UVB, resulting in formation of reactive oxygen species (ROS) and activation of matrix metalloproteinases (MMPs) that contribute to accelerated skin ageing and wrinkling. While these forms of UV radiation have long been considered primary risk factors for photo-induced skin damage and development of skin cancer, investigations of visible and infrared (IR) irradiance also found in complete solar light have revealed that energy from these spectral regions can enhance the damaging effects of ultraviolet light, increasing oxidative stress, MMP activity, and cellular DNA damage in dermal cells. Similar mechanisms of damage induced by UVB energy can lead to long-term deterioration of the critical structures within the eye, making solar radiation a risk factor for conditions like macular degeneration and cataract formation as well.

Although an abundance of evidence has established that severe biological consequences result from solar radiation damage, relatively few options are available to consumers for monitoring personal exposure to sunlight.

Accordingly, there is a need for devices and methods that can be used to monitor sunlight exposure.

### SUMMARY

Described herein is a sensor comprising a porous substrate comprising unaggregated xanthommatin or a salt or a crosslinked derivative thereof.

Also described herein is a sensor comprising a paper substrate comprising xanthommatin or a salt or a crosslinked derivative thereof.

Also described herein is a microfluidic device comprising a sensor described herein, a liquid reservoir, and a channel, wherein the liquid reservoir is in fluid communication with a porous substrate of the sensor via the channel, whereby application of force to the liquid reservoir drives liquid contained therein through the channel to the porous substrate.

Also described herein is a microfluidic device, comprising: a base layer; a second layer adhered to the base layer, the second layer comprising a liquid reservoir and a channel; a third layer adhered to the second layer, the third layer comprising an outlet in contact with the channel; a spacer adhered to the third layer; a sensor described herein in fluid communication with the outlet; and a transmissive layer. The transmissive layer is configured to allow light to reach a porous substrate of the sensor or a portion thereof. The porous substrate is sealed within the device and is within the spacer.

Also described herein is a method of making a sensor described herein, the method comprising incubating a porous substrate with a first mixture comprising xanthommatin or a salt thereof in a first solvent, thereby distributing the xanthommatin or a salt thereof throughout the porous substrate.

Also described herein is the use of a sensor or microfluidic device described herein, e.g., as a solar radiometer and/or UVC radiation detector.

Example features of the sensors described herein include:
Multispectral Performance. Unlike other colorimetric sensors for solar light, these devices can measure multiple energies of UV radiation (UVA, UVB, UVC) as well as visible-near IR energies (400-1100 nm) from solar light.
Intrinsic Photochemical Properties. While many colorimetric light sensing systems are prepared by pairing photosensitive materials with colorimetric indicators (e.g., acid release agents and pH indicators), xanthommatin can naturally undergo photoreduction without any requirements for additional reagents.
Permanent Colorimetric Signals. The radiation-driven color changes demonstrated by these devices are permanent, allowing them to communicate exposure to cumulative radiation doses without requiring the user or additional electronic equipment to track a signal over time.
New microfluidic design. The microfluidic devices designed and fabricated to activate these sensors are completely self-contained, requiring only a brief application of pressure to fill the sensors with fluid. This approach eliminates a need for providing supplemental tools (e.g., pipettes) with the sensor or providing the user with scientific/procedural training.

Example advantages of the sensors described herein include:
Low cost. These devices can be manufactured from laminated paper and plastic films, making them less expensive to fabricate and potentially more accessible than electronic dosimeters.
Multi-use devices. These sensors respond to UVA, UVB, UVC, and visible-IR radiation individually, and solar radiation (UVA/B-visible/IR) and germicidal radiation (UVC) have been identified as preliminary applications. There may be additional opportunities to refine the spectral specificity of these prototypes further by incorporating additional optical filters to the device assembly.
Natural Materials. The reagents used to create some colorimetric UV sensors, such as bypyridinium-based molecules (e.g., viologens) and polyoxometalates (e.g., phosphomolybdic acid), are hazardous to human health. Xanthommatin is a biologically-derived and environmentally-friendly material, which could be presented as an advantage of the systems described herein over existing colorimetric indicators.
This technology performs measurements of multiple forms of solar radiation using a colorimetric detection strategy. Multispectral measurements are primarily performed using electronic systems.

### BRIEF DESCRIPTION OF THE DRAWINGS

The patent or application file contains at least one drawing executed in color. Copies of this patent or patent application publication with color drawings will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A shows the absorbance during xanthommatin photoreduction. In aqueous acidic conditions, absorbance (444 nm) of oxidized xanthommatin is attenuated upon irradiation with solar light, resulting in a color shift from yellow to red. Incorporation of excess cystine causes precipitation of a red solid.

FIG. 1B shows absorbance spectra of the precipitated solid from FIG. 1A which displays an absorbance peak near 480 nm, characteristic of xanthommatin pigment reduced with ascorbic acid. The absorbance spectrum of solubilized material precipitated upon irradiation of acidified xanthommatin in the presence of excess cystine is similar to that of xanthommatin reduced with ascorbic acid, a known reducing agent for the biochrome.

FIG. 1C shows absorbance spectra monitoring acidified solutions of cystine irradiated in the absence of xanthommatin pigment with 4,4′-dithiopyridine (4,4′-DPS). The solutions of FIG. 1C indicate that the absence of xanthommatin does not yield free thiols, thus, xanthommatin is required for formation of redox-active free thiols, as demonstrated by the absence of an absorbance peak indicative of 4-TP near 320 nm in the irradiated sample. N=3 replicates per condition.

FIG. 1D is a chemical reaction schematic showing the photosensitization of cystine by xanthommatin produced free thiols, which alters the visible color of the pigment to yield a red precipitate.

FIG. 1E is a chemical reaction schematic showing that without a photosensitizing agent, disulfides are not converted to thiols upon irradiation with UV light. 4,4′-DPS is used, which is converted to 4-TP by free thiols, to assess whether xanthommatin is required to generate cysteine upon irradiation of cystine in acidic conditions.

FIG. 2A is a schematic of a crosslinked xanthommatin-based light sensor. In the embodiment depicted in FIG. 2A, crosslinked xanthommatin-based sensor (1) is sealed between UV-transmitting or UV-blocking film (2) and polyethylene terephthalate (PET) base layer (3) via double-sided adhesive (4). UV-transmitting or UV-blocking film 2 controls the energy received by the sensor and sealing mitigates evaporation during irradiation.

FIG. 2B is a plot of the Chromaticity (b) of a crosslinked xanthommatin-based light sensor according to FIG. 2A. Sensors are responsive to ultraviolet radiation, with signals in UVB and UVC irradiated devices enhanced by the incorporation of excess cystine. Error bars represent standard deviation of n=3 sensors per condition.

FIG. 2C is a plot of the Chromaticity (b) of a crosslinked xanthommatin-based light sensor according to FIG. 2A. Sensors laminated with UV-blocking films are not responsive to ultraviolet radiation but show dose-dependent photoreduction in response to visible-near infrared radiation (400-1100 nm). Error bars represent standard deviation of n=3 sensors per condition.

FIG. 3A is a plot of the Chromaticity (b) of crosslinked xanthommatin-based light sensors according to FIG. 2A showing measurements of erythemally-weighted radiation from natural sunlight that can visually communicate cumulative doses and risk of sunburn. Signal differences between UV-transmitting and UV-blocking devices demonstrate that pigment photoreduction results from combined effects of radiation spanning multiple spectral ranges. Sensors constructed to respond to only visible-near-IR radiation followed the responses of sensors exposed to complete sunlight, demonstrating that xanthommatin is responsive to energies spanning multiple spectral ranges. Error bars represent standard deviation of n=3 sensors per condition.

FIG. 3B is a plot of the Chromaticity (b) of a UV-transmitting crosslinked xanthommatin-based light sensor according to FIG. 2A showing the sensor responses to controlled doses of visible-near-IR radiation (400-1100 nm) from an arc lamp solar simulator. Error bars represent standard deviation of n=3 sensors per condition.

FIG. 3C is a plot of the Chromaticity (b) of a UV-transmitting crosslinked xanthommatin-based light sensor according to FIG. 2A showing the sensor responses to UVC radiation (254 nm), which is not part of terrestrial solar radiation. Error bars represent standard deviation of n=3 sensors per condition.

FIG. 3D is a plot of the Chromaticity (b) before and after complete solar radiation, showing signal formation in response to complete solar radiation attenuated by coating sensors according to FIG. 2A with mineral and chemical sunscreens.

FIG. 4A is a schematic of a button-activated microfluidic device in accordance with various embodiments described herein. A multilayered device assembly is prepared from patterned, adhesive-backed films which form a microfluidic channel beneath the crosslinked xanthommatin-functionalized paper substrate. The multilayered device assembly includes PET base 11, fluidic channel 12, channel outlet 13, vented spacer 14, crosslinked xanthommatin-based sensor 15 and ethylene tetrafluoroethylene (ETFE) seal 16. When pressure is applied to oval-shaped button 17 at the beginning of the channel, fluid is pushed into the paper-based sensor, which is hydrated with cystine solution via capillary action.

FIG. 4B is an illustration showing that the forces required to activate these devices can be controlled by the volume of solution loaded into the microfluidic channel. Larger volumes sit closer to the channel outlet, requiring smaller forces to traverse the distance to the paper sensor, while the fluid front of smaller fluid volumes is further from the channel outlet, requiring greater activation forces.

FIG. 4C is a plot of the Activation Force (mN) versus Fluid Volume (μL) of microfluidic devices according to FIG. 4A. Forces required to activate these devices depend on the volume of solution loaded into the microfluidic channel. Larger volumes sit closer to the channel outlet, requiring smaller forces to traverse the distance to the paper sensor, while the fluid front of smaller volumes is further from the channel outlet, necessitating greater activation forces. Error bars represent standard deviation of n=3 replicates per condition.

FIG. 4D shows images of a multilayered device assembly according to FIG. 4A prepared from patterned, adhesive-backed films forming a microfluidic channel beneath the crosslinked xanthommatin-functionalized paper sensor. When pressure is applied to the oval-shaped button at the beginning of the channel, fluid is pushed into the paper-based sensor that is then filled by capillary action.

FIG. 5 is an image of the electromagnetic spectrum. The portion of the spectrum spanning from the UV region to the IR region is enlarged to show the approximate wavelength values.

FIG. 6 is a chemical reaction schematic showing the reversible photoreduction of xanthommatin to dihydroxanthommatin by exposure to solar and visible light, resulting in a color change from yellow (xanthommatin) to red (dihydroxanthommatin).

FIG. 7A shows images of xanthommatin-loaded paper sensors, some of which have been crosslinked with 1-ethyl-3-(3-dimethylaminopropyl) carbodiimide (EDC) and some of which are uncrosslinked (control), before and after the reduction of xanthommatin to dihydroxanthommatin by exposure to solar and visible light. The EDC crosslinking step enhances the dynamic range and pigment loading of the xanthommatin-loaded paper sensors.

FIG. 7B shows the process by which paper sensors are xanthommatin-loaded and crosslinked in accordance with various embodiments described herein. The process involves saturating paper (Whatman three punches) with a solution of xanthommatin in hydrochloric acid (HCl) and methanol (MeOH) and allowing the solvent to evaporate, saturating the paper sensors with a solution of a crosslinker (EDC), washing the paper sensors with water, and drying the paper sensors to evaporate the solvents.

FIG. 8A is an image of a crosslinked xanthommatin-loaded paper sensor that is laminated inside UV-transparent films before irradiation.

FIG. 8B shows images of irradiated and control (dark) crosslinked xanthommatin-loaded paper sensors that have been saturated with water, or 2-(N-morpholino) ethanesulfonic acid (MES) buffer at either pH 6 or pH<1. The acidic conditions provide richer colors that are indicative of the reduction of crosslinked xanthommatin to dihydroxanthommatin.

FIG. 8C is a plot of the red, green, and blue (RGB) intensities of the irradiated and control crosslinked xanthommatin-loaded paper sensors of FIG. 8B. The solid red bars represent the red channel pixel intensity of unirradiated control sensors, the red outlined bars represent the red channel pixel intensity of irradiated sensors, the solid green bars represent the green channel pixel intensity of unirradiated control sensors, the green outlined bars represent the green channel pixel intensity of irradiated sensors, the solid blue bars represent the blue channel pixel intensity of unirradiated control sensors, and the blue outlined bars represent the blue channel pixel intensity of irradiated sensors. The pH of each sensor was controlled using different hydrating fluids for these experiments, as identified by the labels on the x-axis of FIG. 8C (e.g., water, MES, acidic MES).

FIG. 9A is a chemical reaction scheme of the photosensitization of cystine in UV light. FIG. 9A shows the breaking of the disulfide bond of cystine to form cysteine upon the exposure of cystine to UV light.

FIG. 9B shows images of irradiated and control (dark) xanthommatin-loaded paper sensors that have been saturated with water, MES buffer at either pH 6 or pH<1, or a solution of 100 mM cystine and acidified MES buffer. Incorporating disulfide compounds enhances the color range and saturation upon photoreduction of xanthommatin.

FIG. 9C is a plot of the RGB intensities of the irradiated and control xanthommatin-loaded paper sensors of FIG. 9B. The solid red bars represent the red channel pixel intensity of unirradiated control sensors, the red outlined bars represent the red channel pixel intensity of irradiated sensors, the solid green bars represent the green channel pixel intensity of unirradiated control sensors, the green outlined bars represent the green channel pixel intensity of irradiated sensors, the solid blue bars represent the blue channel pixel intensity unirradiated control sensors, and the blue outlined bars represent the blue channel pixel intensity irradiated sensors. When sensors in a hydrating solution of MES buffer were supplemented with the disulfide cystine, the visible color change observed upon irradiation was more intense than in sensors in buffer that did not contain cystine.

FIG. 10 is a bar graph showing the hourly UV index in Burlington, Massachusetts on Jul. 23, 2021.

FIG. 11 shows images of a button-activated microfluidic device without and with a paper sensor. The reservoir and channel are filled with a cystine solution that, when force is applied, will flow to and fill the sensor by capillary action. The button-activated microfluidic device pumps without electricity or accessories, which provides simplified sensing on-location.

FIG. 12 shows images of a dime for size comparison, top and bottom views of a button-activated microfluidic device comprising a dry crosslinked xanthommatin-based sensor, and a button-activated microfluidic device comprising a hydrated crosslinked xanthommatin-based sensor before and after exposure to light (1 J cm-2 UVB). This wearable and mountable microfluidic device allowed dry xanthommatin-based sensors to be activated with acidified cystine solution immediately before use.

FIG. 13 is an image of a crosslinked xanthommatin-loaded paper sensor saturated with a basic solution which destroys the crosslinked xanthommatin pigment.

FIG. 14A is an image of EDC-crosslinked, xanthommatin-loaded paper sensors made under the same conditions as the xanthommatin-loaded paper sensors in FIG. 9B after irradiation with simulated solar light (sublight). The sensors hydrated with MES at a pH of 6 are browner in color than the sensors hydrated with water. The sensors hydrated with MES under acidic conditions with a pH<1 are redder in color than the sensors hydrated with MES at a pH of 6. The addition of a cystine solution to the sensors provides substantial enhancement over the acidic MES sensors.

FIG. 14B is an image of EDC-crosslinked, xanthommatin-loaded paper sensors made under the same conditions as the xanthommatin-loaded paper sensors in FIG. 9B before irradiation with simulated solar light.

FIG. 14C is a plot of the channel intensities of the irradiated and control xanthommatin-loaded paper sensors of FIGS. 14A-B. The solid red bars represent the red channel pixel intensity of unirradiated control sensors, the red outlined bars represent the red channel pixel intensity of irradiated sensors, the solid green bars represent the green channel pixel intensity of unirradiated control sensors, the green outlined bars represent the green channel pixel intensity of irradiated sensors, the solid blue bars represent the blue channel pixel intensity unirradiated control sensors, and the blue outlined bars represent the blue channel pixel intensity irradiated sensors. When sensors in a hydrating solution of MES buffer were supplemented with the disulfide cystine, the visible color change observed upon irradiation was more intense than in sensors in a hydrating solution that did not contain cystine.

FIG. 15 is a transmittance spectrum of thick and thin PET films, and thick and thin ETFE films across a range of wavelengths (200 nm to 800 nm).

FIG. 16 is a plot of xanthommatin photochemistry in neutral conditions. Solutions of 1 mM oxidized xanthommatin and 1 mM cystine prepared in MES buffered to pH 6.0 shifted from yellow to dark brown after 90 minutes of irradiation with simulated solar light. Similar shifts in visible color and absorbance at 444 nm were observed in solutions containing only xanthommatin alone. Error bars represent standard deviation of n=3 measurements per condition.

FIG. 17 is a plot of sensor responses to indoor lighting. Dry sensors and sensors hydrated with cystine solution exhibited minimal color change after 3 hours of irradiation by indoor fluorescent lighting. The total visible-near IR radiation dose delivered to irradiated sensors was 54 mJ cm⁻². Error bars represent standard deviation of n=3 measurements per condition.

FIG. 18 is a plot of the saturation of crosslinked xanthommatin-based radiation sensors. Sensors exposed to increasing doses of UVC radiation did not provide increasing measured chromaticity values for doses above 300 mJ cm⁻². Error bars represent standard deviation of n=3 measurements per condition.

FIG. 19 shows chemical structures of xanthommatin evaluated using computational methods. Label colors correspond with comparisons of chemical hardness reported in Table 1.

FIG. 20 shows frontier orbitals analysis of xanthommatin structures displayed in FIG. 19. Structures “Xa6” and “Xa8” are not displayed because they are equivalent to structures “Xa2” and “Xa4,” respectively.

FIG. 21A shows the atomic positions of electronic transitions that are possible for each xanthommatin structure based on the energy gaps calculated in Table 3.

FIG. 21B is a plot showing that the Energy (eV) of UVC radiation is sufficient to complete the HOMO-to-LUMO electronic transition (Gap) but not further, higher-energy transitions (T1, T2, and T3), for the Xa1 xanthommatin structure of FIG. 21A.

FIG. 22 are images evaluating the fluid evaporation in microfluidic devices. Multilayered microfluidic devices showed evaporative loss of stored dye solution when placed in a desiccant jar (1:1 w/w phosphorous pentoxide and potassium hydroxide) and removed for imaging at 15 minute intervals. Solution loss appeared to occur exclusively through the vent port of each device. Red dotted line indicates the initial position of the fluid front, red circles track the position of the fluid front after t=0 min. Scale bars=3 mm.

FIG. 23 is an absorbance spectrum of oxidized xanthommatin dissolved in MES buffer (50 mM pH 6.0).

FIG. 24 is a plot of the extinction coefficient of xanthommatin. The estimated concentration of a solution of oxidized xanthommatin was calculated based on the assumption that all starting material (3 hydroxykynurenine) was converted to the desired product in the synthesis of xanthommatin. The absorbance of three dilutions of this stock solution was measured at 444 nm to determine the extinction coefficient of the redox-active chromophore in the reaction product mixture. N=3 measurements per concentration, error bars (standard deviation) too small to be displayed.

FIG. 25 is a transmittance spectrum of plastic films used to construct laminated light sensors and microfluidic devices.

FIG. 26 is an image of the force measurement apparatus. Forces applied to the channel reservoir of microfluidic devices were measured by iteratively increasing the mass pressing on the surface of the device. These forces were applied directly to the reservoir volume by the end of a cotton-tipped applicator connected to an open plastic container, which was filled with increasing mass to drive fluid through the device. The applicator was held approximately normal to the surface of the balance using a steel tap guide attached to a laboratory ring stand.

### DETAILED DESCRIPTION

A description of example embodiments follows.

The most accessible methods for preventing damage from solar radiation are regulation of exposure time according to environmental conditions and use of photoprotective barriers such as clothing, sunglasses, and sunscreen. However, adhering to photoprotective practices is challenging for many, owing in part and for example to the aesthetic appeal of achieving a suntan, occupational requirements for sustained time outdoors, and concerns surrounding biological side-effects of the active ingredients in sunscreen. Additionally, public reporting of weather-dependent sun safety information, such as the UV index, does not necessarily result in the avoidance of high-risk outdoor activities. As atmospheric degradation increases doses of solar radiation experienced in daily life, wearable devices for monitoring exposure to solar radiation have emerged as practical tools for personal health. These technologies hold the potential to increase public awareness of solar radiation risks, and potentially shift behavior toward photoprotective habits that minimize negative health outcomes associated with overexposure to the sun.

Most wearable dosimeters are calibrated to respond to erythemally weighted UV radiation (UV_{Ery}), a representation of irradiance designed to convey the relative effectiveness of wavelengths within the ultraviolet spectral range at inducing erythema, reddening of the skin characteristic of sunburning. Erythemally weighted irradiance is also part of the mathematical basis of the UV index. Human skin types classified according to increasing levels of melanin pigmentation require increasing doses of UV_{Ery} to produce erythema, and the term minimum erythemal dose (MED) is used to describe these thresholds in observational studies of sunburning in individuals. Because MEDs vary across skin types and radiation conditions, a standard erythemal dose (SED) of 10 mJ cm⁻² is a common measurement unit for wearable UV sensors, with cumulative doses compared to MED values spanning 20-200 mJ cm⁻² for Fitzpatrick skin types I-VI. Systems that report cumulative doses of radiant energy, rather than time-independent power density, can effectively signal important relationships between user behavior and the risk of radiation-induced skin damage for specific skin types.

Although UVB radiation is the basis of most public information about sun safety, radiation induced biological damage results from synergistic effects of energy spanning multiple spectral regions, making it challenging to design sensors that fully capture and communicate the risks of overexposure to sunlight. Handheld electronic radiometers provide measurements of erythemally weighted UV irradiance on-demand but are not practical for monitoring continuous exposure during outdoor activities. Non-electronic systems that change color in response to UV radiation have been developed as cost-effective dosimetry options, with visual changes driven by photodegradation of dyes distributed throughout polymeric films or paper, radiolysis of acid-containing agents in the presence of pH indicators, and photoreduction of bipyridinium derivatives (e.g., viologens) or polyoxometalate indicators. These measurement approaches can be packaged in planar geometries as wearable wristbands or stickers, but cannot provide the depth of wavelength-specific, quantitative information offered by more expensive electronic sensors. Recent advances in miniaturized electronics have enabled development of wearable electronic systems that wirelessly report doses of UV, visible, and infrared radiation to the user's cell phone. Measuring across discrete sections of a broad spectral range, these technologies provide the quantitative performance of electronic sensors in a durable, wearable form factor. However, opportunities for creating cost-effective, single-use personal dosimeters using colorimetric strategies for measuring multiple forms of radiation remain incompletely explored.

In the work described herein, wearable light sensors based on xanthommatin, a natural biochrome that controls the appearance of cephalopod skin, filters light in fruit fly eyes, and signals sexual maturation in dragonflies, is described. Previous evaluations of the optical properties of xanthommatin have suggested that the oxidation state of the biochrome changes in response to solar light, resulting in radiation-controlled changes in visible color.

Herein, aqueous acidic conditions in which xanthommatin undergoes permanent photoreduction have been identified and the resulting dose-dependent colorimetric responses leveraged to create disposable wearable radiometers. In the characterization of these sensors, it was discovered that they were not only responsive to the ultraviolet, visible, and near IR wavelengths occurring in natural sunlight, but also changed color in response to UVC radiation. Computational models of xanthommatin structures were also developed, and density functional theory (DFT) calculations were performed to evaluate how the xanthommatin-based sensors are impacted by different radiation energies. Through this exploration, it was discovered that these wearable radiometers were not only responsive to the UV, visible, and near-IR wavelengths occurring in natural sunlight but they also changed color in response to UVC radiation, highlighting the versatility of this single photoresponsive material for a variety of applications.

Energy from this spectral region does not reach the Earth's surface from the sun, but presents as an occupational hazard (e.g., welding) and serves as an effective method of germicidal sterilization. To demonstrate the utility of the sensors as wearable solar radiometers or mountable indicators for germicidal irradiation with UVC energy, these sensors have been incorporated into self-contained, button-activated microfluidic devices prepared by lamination of inexpensive, adhesive-backed plastic films. These prototypes represent an important advancement toward quantitative measurements of solar radiation across multiple biologically relevant spectral regions, without requirements for electronic components or advanced manufacturing strategies.

Ultraviolet, Visible, and/or Infrared Radiation Sensors and Microfluidic Devices

Accordingly, described herein is a porous substrate comprising unaggregated xanthommatin or a salt or a crosslinked derivative thereof.

Also described herein is a sensor comprising a paper substrate comprising xanthommatin or a salt or a crosslinked derivative thereof.

As used herein, singular articles such as “a,” “an” and “the,” and similar referents are to be construed to cover both the singular and the plural, unless otherwise indicated herein or clearly contradicted by context. For example, reference to “a sensor” may refer to one or more sensors. When a referent refers to the plural, the members of the plural can be the same as or different from one another.

“About” means within an acceptable error range for the particular value, as determined by one of ordinary skill in the art. Typically, an acceptable error range for a particular value depends, at least in part, on how the value is measured or determined, e.g., the limitations of the measurement system. For example, “about” can mean within an acceptable standard deviation, per the practice in the art. Alternatively, “about” can mean a range of +20%, e.g., +10%, +5% or #1% of a given value. It is to be understood that the term “about” can precede any particular value specified herein, except for particular values used in the Exemplification.

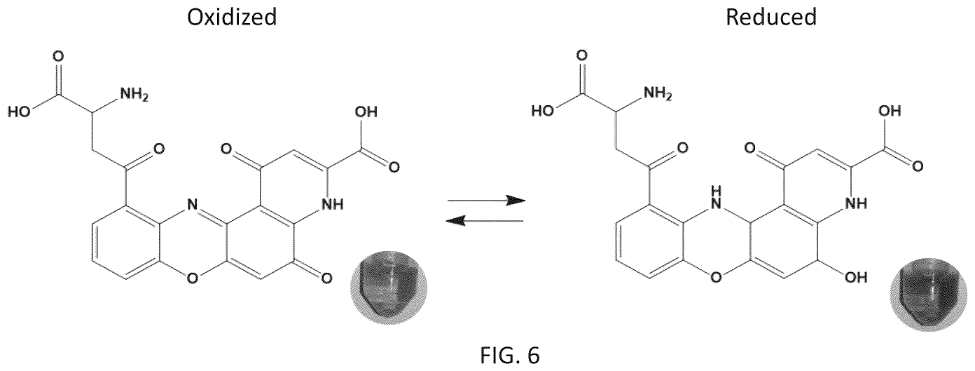

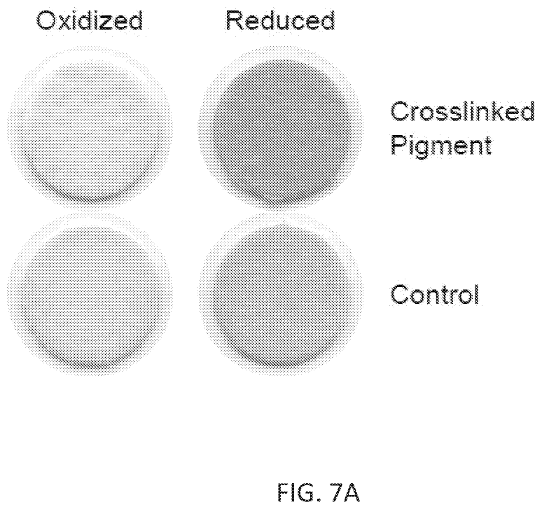

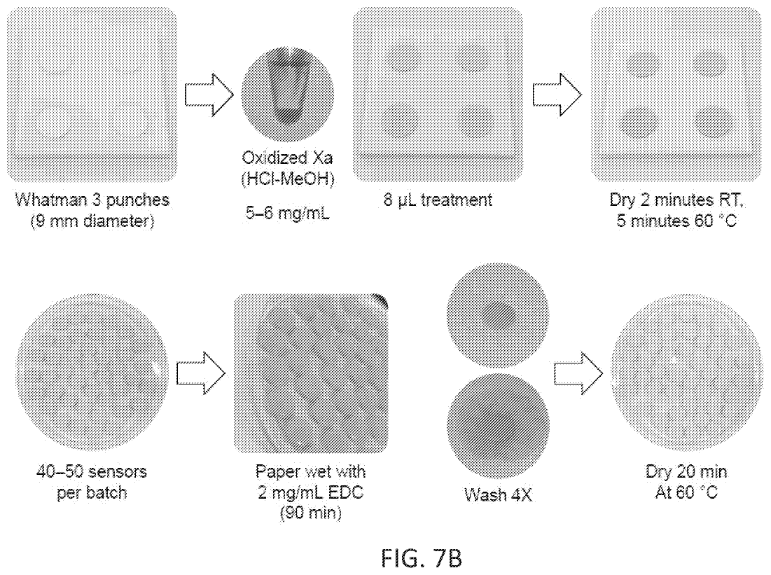

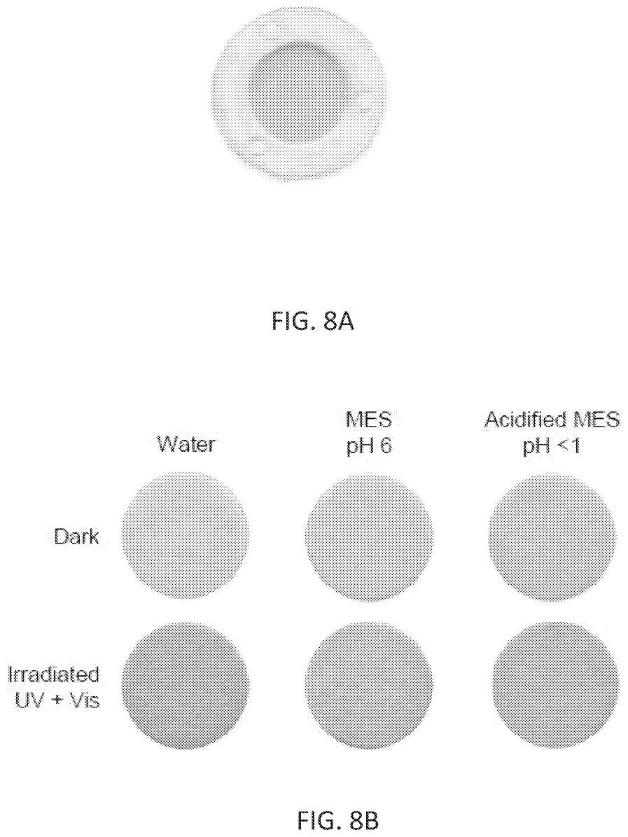

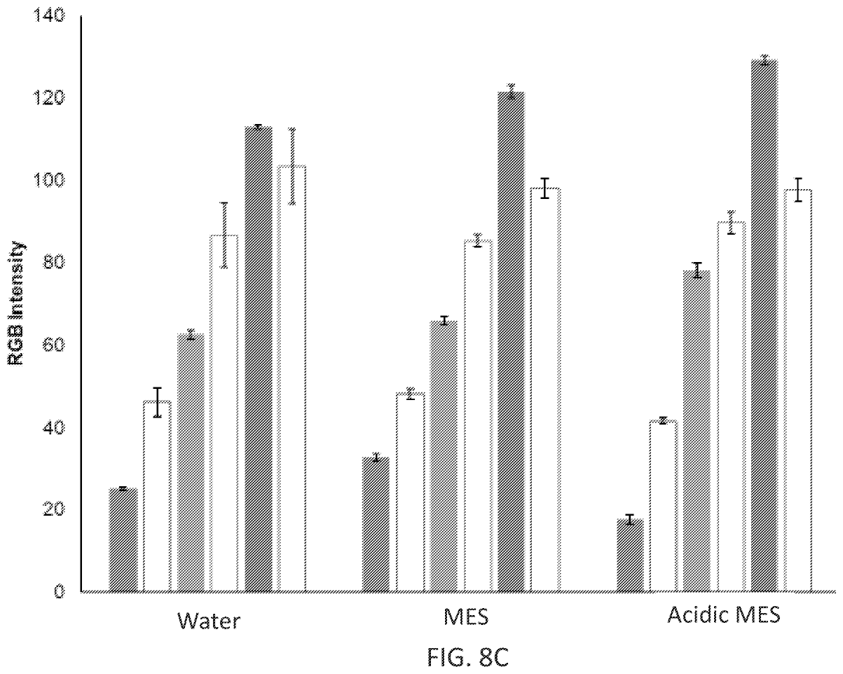

As used herein, “xanthommatin” refers to 11-(3-amino-3-carboxypropanoyl)-1,5-dioxo-4H-pyrido[3,2-a]phenoxazine-3-carboxylic acid. The chemical structure of xanthommatin is shown in FIG. 6. Xanthommatin and various of its precursors and derivatives can be extracted from cephalopods (e.g., squid Doryteuthis pealeii chromatophores) and other natural sources, such as the eyes, integumentary system, organs, and eggs of arthropods. Xanthommatin and its precursors and derivatives can also be synthesized using methods described herein and/or known in the art. For example, Williams, T. L.; Lopez, S. A.; Deravi, L. F., ACS Sustainable Chemistry & Engineering 2019 7 (9), 8979-8985, the entire content of which is incorporated herein by reference, discloses the synthesis of xanthommatin via the electro-catalyzed oxidation of tryptophan metabolites.

Salts of the compounds described herein (e.g., xanthommatin, dihydroxanthommatin) include salts derived from suitable inorganic and organic acids, and suitable inorganic and organic bases.

Examples of acid addition salts are salts of an amino group formed with inorganic acids such as hydrochloric acid, hydrobromic acid, phosphoric acid, sulfuric acid and perchloric acid, or with organic acids such as acetic acid, trifluoroacetic acid, oxalic acid, maleic acid, tartaric acid, citric acid, succinic acid or malonic acid or by using other methods used in the art, such as ion exchange. Other pharmaceutically acceptable acid addition salts include adipate, alginate, ascorbate, aspartate, benzenesulfonate, benzoate, bisulfate, borate, butyrate, camphorate, camphorsulfonate, cinnamate, citrate, cyclopentanepropionate, digluconate, dodecylsulfate, ethanesulfonate, formate, fumarate, glucoheptonate, glycerophosphate, gluconate, glutarate, glycolate, hemisulfate, heptanoate, hexanoate, hydroiodide, hydroxybenzoate, 2-hydroxy-ethanesulfonate, hydroxymaleate, lactobionate, lactate, laurate, lauryl sulfate, malate, maleate, malonate, methanesulfonate, 2-naphthalenesulfonate, nicotinate, nitrate, oleate, oxalate, palmitate, pamoate, pectinate, persulfate, 2-phenoxybenzoate, phenylacetate, 3-phenylpropionate, phosphate, pivalate, propionate, pyruvate, salicylate, stearate, succinate, sulfate, tartrate, thiocyanate, p-toluenesulfonate, undecanoate, valerate salts, and the like.

Salts derived from appropriate bases include salts derived from inorganic bases, such as alkali metal, alkaline earth metal, and ammonium bases, and salts derived from aliphatic, alicyclic or aromatic organic amines, such as methylamine, trimethylamine and picoline, or N″ ((C₁-C₄)alkyl)₄ salts. Representative alkali or alkaline earth metal salts include sodium, lithium, potassium, calcium, magnesium, barium and the like. Further salts include, when appropriate, nontoxic ammonium, quaternary ammonium, and amine cations formed using counterions such as halide, hydroxide, carboxyl, sulfate, phosphate, nitrate, lower alkyl sulfonate and aryl sulfonate.

Salts of 11-(3-amino-3-carboxypropanoyl)-1,5-dioxo-4H-pyrido[3,2-a]phenoxazine-3-carboxylic acid, or a derivative or precursor thereof, can be prepared from a parent compound that contains a basic or acidic moiety by conventional chemical methods. Generally, such salts can be prepared by reacting the free acid or free base form of the parent compounds with a stoichiometric amount of an appropriate base or acid, respectively, in a suitable medium, such as water, an organic solvent, or a mixture of water and an organic solvent. Typically, nonaqueous media, such as ether, ethyl acetate, ethanol, isopropanol, or acetonitrile, are preferred.

Crosslinked derivatives of xanthommatin include molecules and/or polymers comprising two or more xanthommatin molecules covalently linked to one another by a bond or sequence of bonds. It will be appreciated that xanthommatin has carboxylic acid (or carboxylate) and amino functional groups, each of which can, under suitable conditions (e.g., in the presence of a crosslinker), react with a suitable reaction partner to form an intermolecular bond, e.g., to one or more different xanthommatin molecules.

Commonly formed groups in a reaction involving an amine, especially a primary amine (—NH₂) as is present in xanthommatin, and a crosslinker, include amides (formed, e.g., by reaction of a N-hydroxysuccinimide ester and an amine) and amidines (formed, e.g., by reaction of an imidoester and an amine). Other functional groups that react with amines, especially primary amines, to form various residues include isothiocyanates, isocyanates, sulfonyl chlorides, aldehydes, carbodiimides, acyl azides, anhydrides, fluorobenzenes, carbonates, epoxides and fluorophenyl esters. Thus, “amine-reactive groups” or “amine-reactive functional groups” include N-hydroxysuccinimide esters, imidoesters, isothiocyanates, isocyanates, sulfonyl chlorides, aldehydes, carbodiimides, acyl azides, anhydrides, fluorobenzenes, carbonates, epoxides and fluorophenyl esters.

Commonly formed groups in a reaction involving a carboxylic acid (—COOH) or carboxylate (—COO⁻) and a crosslinker include amides (formed, e.g., by reaction of an amine with a carboxylic acid or carboxylate in the presence of a carbodiimide, such as 1-ethyl-3-(3-dimethylaminopropyl) carbodiimide (EDC) or dicyclohexylcarbodiimide (DCC)). Thus, “carboxyl-reactive groups” or “carboxyl-reactive functional groups” include carbodiimides.

“Crosslinker,” as used herein, refers to a molecule that, under appropriate conditions, can react with two or more other molecules (e.g., two xanthommatin molecules) to provide a covalent connection between them. To provide the requisite connection, a crosslinker will often be at least bifunctional, e.g., will contain at least two reactive groups attached to each other via a linker (such as an aliphatic or polyethylene glycol linker), wherein the reactive groups facilitate attachment of the two or more other molecules, although so-called zero-length crosslinkers can also provide a covalent connection between two or more molecules. Crosslinkers are well-known in the art, and include homobifunctional crosslinkers and heterobifunctional crosslinkers. Crosslinkers are also described, for example, in Bionconjugation Technical Handbook, ThermoFisher Scientific, COL06007 0818, the entire content of which is incorporated herein by reference.

“Zero-length crosslinker,” as used herein, refers to a crosslinker that facilitates formation of a direct covalent connection between two or more (but typically two) other molecules. Examples of zero-length crosslinkers include 1-ethyl-3-(3-dimethylaminopropyl) carbodiimide (EDC), dicyclohexylcarbodiimide (DCC), Woodward's Reagent K, 1-[3-(dimethylamino) propyl]-3-ethylcarbodiimide methiodide, N-hydroxysuccinimide, N-hydroxysulfosuccinimide and N,N′-carbonyldiimidzole.

“Homobifunctional crosslinker,” as used herein, refers to a crosslinker having two identical functional groups attached to one another via a linker. An example of a homobifunctional crosslinker is disuccinimidylsuberate.

“Heterobifunctional crosslinker,” as used herein, refers to a crosslinker having two different functional groups attached to one another via a linker. Often, the functional groups in a heterobifunctional crosslinker have orthogonal, or selective, reactivity, meaning they allow sequential conjugations with two or more other molecules and minimize undesired conjugation reactions and/or polymerization. Examples of heterobifunctional crosslinkers include sulfosuccinimidyl 4-(N-maleimidomethyl)cyclohexane-1-carboxylate.

Methods of synthesizing crosslinked derivatives of xanthommatin therefore include reacting xanthommatin, or a salt thereof, with a crosslinker (e.g., a zero-length crosslinker), for example, as described herein.

The phrase “xanthommatin or a salt or a crosslinked derivative thereof,” as used herein, includes xanthommatin, a salt of xanthommatin, a crosslinked derivative of xanthommatin, a crosslinked derivative of a salt of xanthommatin and a salt of a crosslinked derivative of xanthommatin.

In some aspects, the xanthommatin or a salt or a crosslinked derivative thereof is unaggregated xanthommatin or a salt or a crosslinked derivative thereof. For example, the method described in the Exemplification herein, wherein xanthommatin, or a salt thereof, is dissolved in a solvent which is used to saturate a substrate is believed to result in distribution of unaggregated xanthommatin, or a salt thereof, throughout the substrate, subsequent crosslinking to produce crosslinked xanthommatin notwithstanding. Substrates comprising aggregated xanthommatin, or a salt or a crosslinked derivative thereof, on the other hand, can be prepared by applying insoluble aggregates of xanthommatin, or a salt or crosslinked derivative thereof, to the substrate.

In some aspects, the xanthommatin or a salt or a crosslinked derivative thereof is uniformly distributed throughout the substrate, e.g., as when the substrate is saturated with a solution comprising the xanthommatin or a salt thereof. In some aspects, the substrate comprises xanthommatin or a salt thereof. In some aspects, the substrate comprises a crosslinked derivative of xanthommatin or a salt thereof. In some aspects, the substrate comprises crosslinked xanthommatin or a salt thereof.

Crosslinked derivatives of xanthommatin wherein each xanthommatin molecule is directly bonded to one more different xanthommatin molecules, e.g., crosslinked derivatives of xanthommatin formed using a zero-length crosslinker, are also referred to herein as “crosslinked xanthommatin.”

In some aspects, the substrate further comprises a disulfide compound. Without wishing to be bound by any particular theory, it is believed that xanthommatin sensitizes disulfide bonds in disulfide compounds to cleavage upon exposure to UV radiation, thereby promoting conversion of the disulfide compounds into free thiols, which, in turn, reduce xanthommatin or a salt or a crosslinked derivative thereof, and create a more intense color change compared to the reduction of xanthommatin or a salt or a crosslinked derivative thereof in the absence of the disulfide compound. The disulfide compounds thus enhance the color change of xanthommatin to dihydroxanthommatin.

Examples of disulfide compounds include: cystine and glutathione disulfide. In some aspects, the disulfide compound is cystine.

Porous substrates include organic and inorganic porous materials. Examples of organic porous substrates include textiles (e.g., fabric) and paper. In some aspects, the porous substrate is a textile. In some aspects, the porous substrate is a fabric, such as a blended fabric, such as rayon or polypropylene. In some aspects, the porous substrate (e.g., textile, fabric) comprises nitrocellulose, nylon, or cotton. In some aspects, the porous substrate is a paper substrate.

As used herein, “paper substrate” refers to a thin sheet formed of a plurality of fibers. The fibers are often comprised of cellulose, cotton, wheat straw, sugar cane waste, flax, bamboo, wood, linen rags, or hemp, and can be naturally or synthetically derived. Typically, the fibers are pressed to form the thin sheet. In some aspects, the paper substrate is filter paper.

In some aspects, the substrate is planar.

In some aspects, the substrate further comprises one or more (e.g., one, two, three, four, five, etc.) additional molecules that impart a color. For example, an additional molecule that imparts a color can be used to create a blended color with xanthommatin. In some aspects, the additional molecule(s) imparts a red color, an orange color, a yellow color, a green color, a blue color, a purple color, a pink color, a black color, or a white color.

In some aspects, the molecule that imparts a color is a dye. Examples of dyes include: erioglaucine (acid blue 9), disodium 6-hydroxy-5-[(2-methoxy-5-methyl-4-sulfophenyl) azo]-2-naphthalenesulfonate (Allura Red/Red 40), or malachite green.

In some aspects, the molecule that imparts a color is a pigment. Examples of pigments include: titanium dioxide, red iron oxide, yellow iron oxide, carbon black, or Prussian Blue. The pigment can also be an animal derived pigment such as carmine (also called cochineal) can be included. Cochineal extract has a bright red color obtained from the aluminum salt of carminic acid. The characteristic deep red color is produced from some insects such as the cochineal scale and certain Porphyrophora species. Carmine is the only organic colorant exempt from certification by the US FDA. Inorganic oxides, such as iron oxides, (yellow, red, brown) can also be included, for example, in the development of color cosmetics.

In some aspects, the molecule that imparts a color is a colorant. Examples of colorants include: colorants colored purple (e.g., ultramarine violet (Al); han purple (Cu); cobalt violet; purple of cassius (Au), etc.), blue (e.g., cobalt blue; Egyptian blue (Cu); Prussian blue (Fe); etc.), green (e.g., cadmium green; chrome green (Cr); Scheele's green (Cu); etc.), yellow (e.g., orpiment (As); primrose yellow (Bi); naples yellow (Pb); etc.), orange (e.g., bismuth vanadate orange; cadmium pigments; etc.), red (e.g., red ochre (Fe); cinnabar (Hg); burnt sienna (Fe); carmine (Al); etc.), and white (e.g., antimony white; lithopone (Ba); cremnitz white (Pb); etc.).

In some aspects, the molecule that imparts a color is a molecule that can change color upon exposure to light. Examples of molecules that can change color upon exposure to light include viologens, which shift from clear to blue upon exposure to light. It is believed that the combination of xanthommatin, which shifts from yellow to red upon exposure to light, and a viologen could be used to create a sensor that shifts from yellow to purple upon exposure to light.

In some aspects, the color imparted by xanthommatin or a salt or crosslinked derivative thereof, or the combination of xanthommatin or a salt or crosslinked derivative thereof and one or more additional molecules that impart a color, shifts by 5 or more, e.g., 10 or more or 15 or more, chromaticity units upon irradiation, e.g., with solar light. Chromaticity can be measured using a spectrophotometer and image analysis software. Chromaticity can also be calculated according to Example 13 of the Exemplification.

In some aspects, the substrate is dry. In alternative aspects, the substrate is wet, e.g., wet with a liquid. The substrate can be wet with a liquid selected from water, an organic solvent or a combination thereof. It may be preferable that the substrate be wet with a nonvolatile liquid, such as water. In some aspects, the substrate is wet with an aqueous solution. In some aspects, the aqueous solution is buffered. In further or alternative aspects, the aqueous solution is acidic. In further aspects, the aqueous solution has a pH of less than about 7, e.g., of about 0 to about 7 about 0 to about 6, about 0 to about 5, about 0 to about 4, about 0 to about 3, about 0 to about 2, about 0 to about 1, or less than about 1.

In some aspects, the liquid (e.g., aqueous solution) further comprises a disulfide compound. Examples of disulfide compounds include any of those cited herein in connection with the description substrate.

In some aspects, the liquid further comprises one or more additional molecules that impart a color. Examples of one or more additional molecules that impart a color include any of those cited herein in connection with the description substrate.

In some aspects, the sensor is sealed inside a chamber, at least a portion of which is transmissive and is configured to allow light to reach the substrate or a portion thereof. In some aspects, the chamber is formed at least in part by a transmissive film configured to allow light to reach the substrate or a portion thereof. In some aspects, the chamber is formed by a transmissive film configured to allow light to reach the substrate or a portion thereof adhered to a base. In some aspects, the base is a film, e.g., a transmissive film, such as any of the transmissive films described herein.

As used herein, “transmissive” refers to the ability of a film or material to allow light/radiation to pass through. A transmissive film can be transmissive to all wavelengths of light, or transmissive to particular wavelengths of light such as UV, visible, near-IR, and/or IR light. UV light can be characterized as light having a wavelength of about 200 nm to about 400 nm. Visible light can be characterized as light having a wavelength of about 380 nm to about 780 nm. In some aspects, visible light can characterized as light having a wavelength of about 400 nm to about 700 nm. Near-IR light can be characterized as light having a wavelength of about 700 nm to about 1100 nm. IR light can be characterized as light having a wavelength of about 1100 nm to about 1,000,000 nm. Examples of transmissive films include: ethylene tetrafluoroethylene (ETFE; which is transmissive to UV radiation and blocks longer wavelengths of light), polyester, polyethylene terephthalate (PET; which is transmissive to long UV wavelengths (e.g., UVA) and blocks UVB/UVC radiation), and acrylic plastic formulations, which can be designed to transmit visible light while blocking or transmitting UV light.

In some aspects, the sensor comprises a base; a spacer; and a transmissive film adhered to the base via the spacer, wherein: the transmissive film is configured to allow light to reach the substrate or a portion thereof; and the substrate is sealed within the sensor, and is within the spacer. In some aspects, the transmissive film is UV-transparent or UV-blocking.

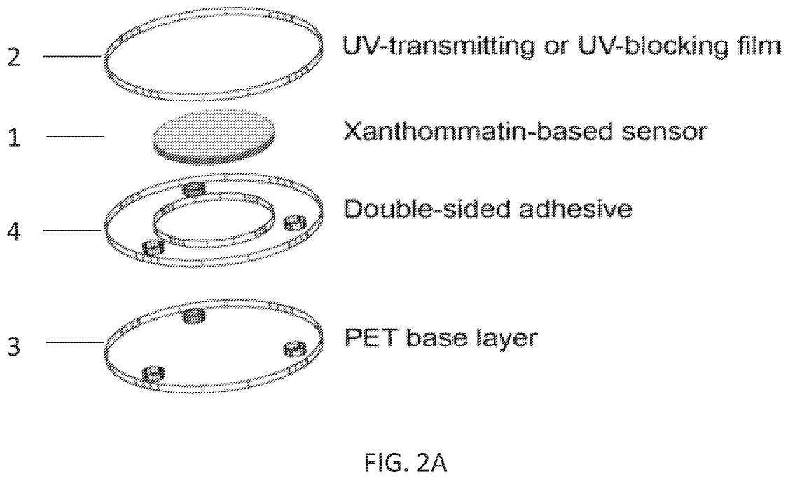

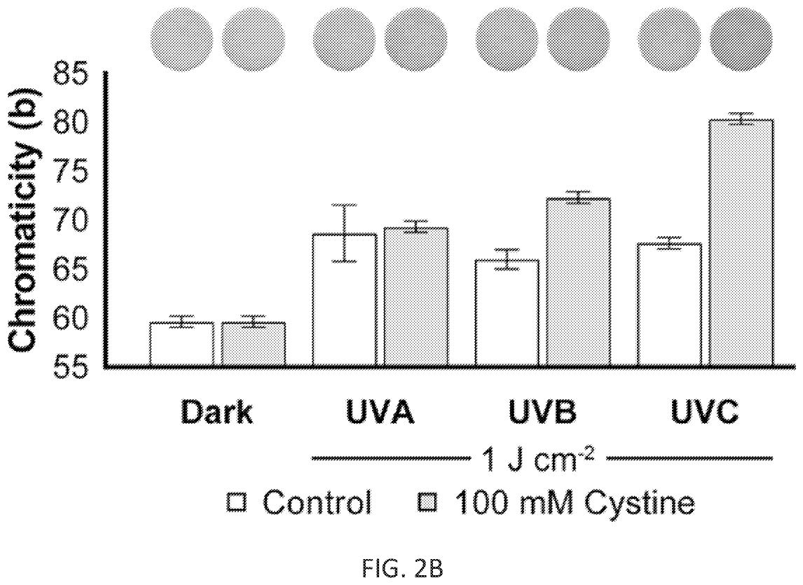

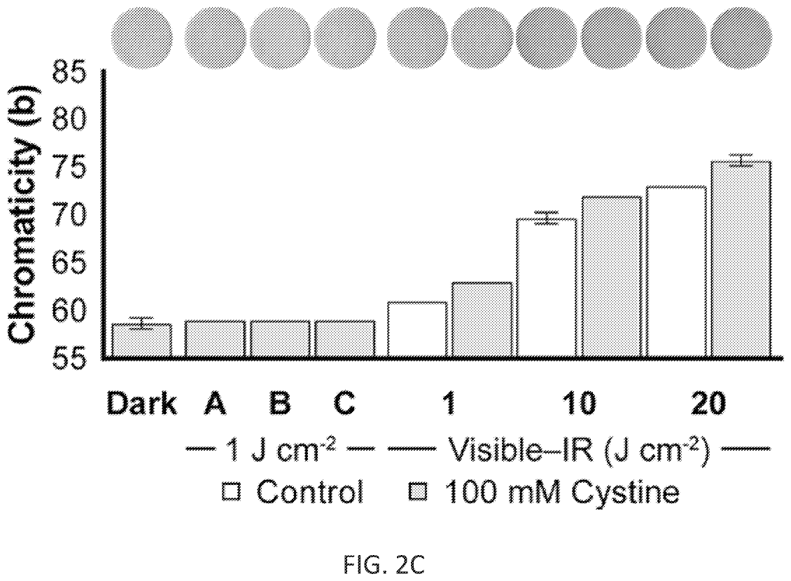

For example, FIG. 2A shows a specific embodiment of a sensor described herein. In the embodiment depicted in FIG. 2A, a crosslinked xanthommatin-based sensor (1) is sealed between a UV-transmitting or UV-blocking film (2) and a polyethylene terephthalate (PET) base layer (3) via a double-sided adhesive (4). The top layer of each sealed sensor could be a UV-transmitting ethylene tetrafluoroethylene (ETFE) film or a UV-blocking polyester film to include or exclude energy from ultraviolet wavelengths, respectively.

In some aspects, the sensor imparts a colorimetric output in response to solar irradiation. In further aspects, the sensor imparts a colorimetric output in response to UVC irradiation.

Also described herein is a microfluidic device, comprising: a sensor described herein, a liquid reservoir; and a channel, wherein the liquid reservoir is in fluid communication with the substrate via the channel, whereby application of force to the liquid reservoir drives liquid contained therein through the channel to the substrate.

Also described herein is a microfluidic device, comprising: a base layer; a second layer adhered to the base layer, the second layer comprising the liquid reservoir and the channel; a third layer adhered to the second layer, the third layer comprising an outlet in contact with the channel; a spacer adhered to the third layer; a sensor described herein in fluid communication with the outlet; and a transmissive layer, wherein: the transmissive layer is configured to allow light to reach the substrate or a portion thereof; and the substrate is sealed within the device and is within the spacer.

In some aspects, the outlet layer further comprises a fill port or a vent port, or both in fluid communication with the liquid reservoir.

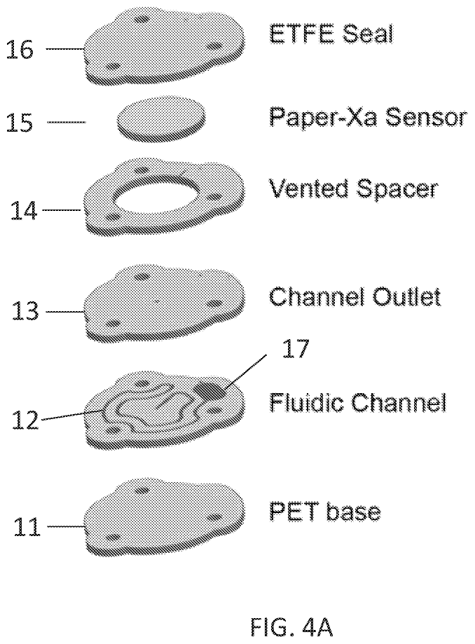

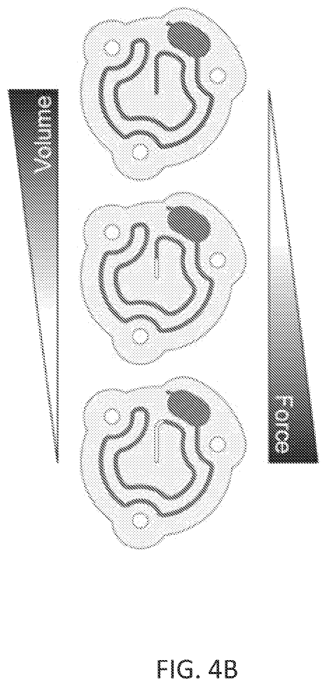

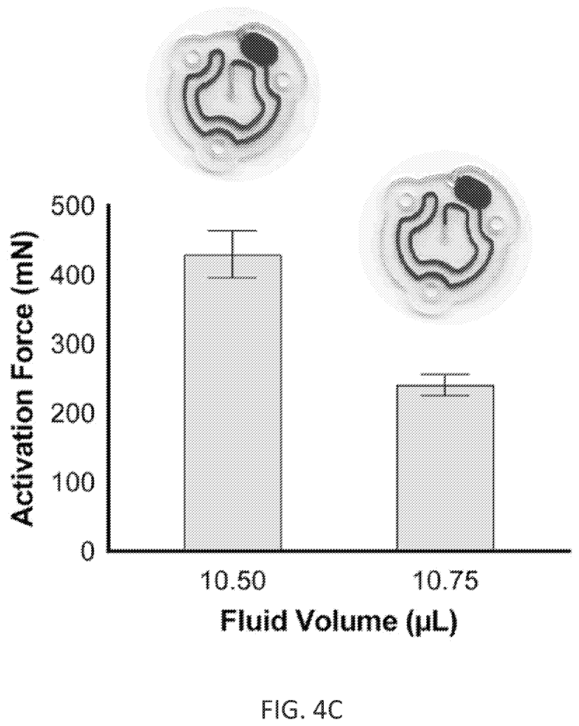

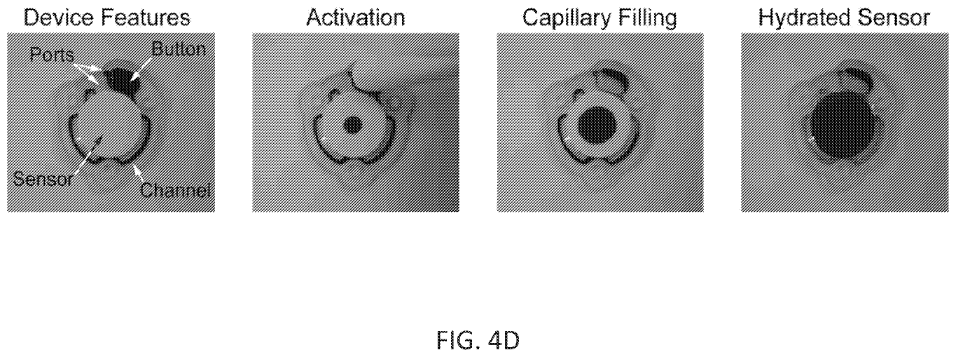

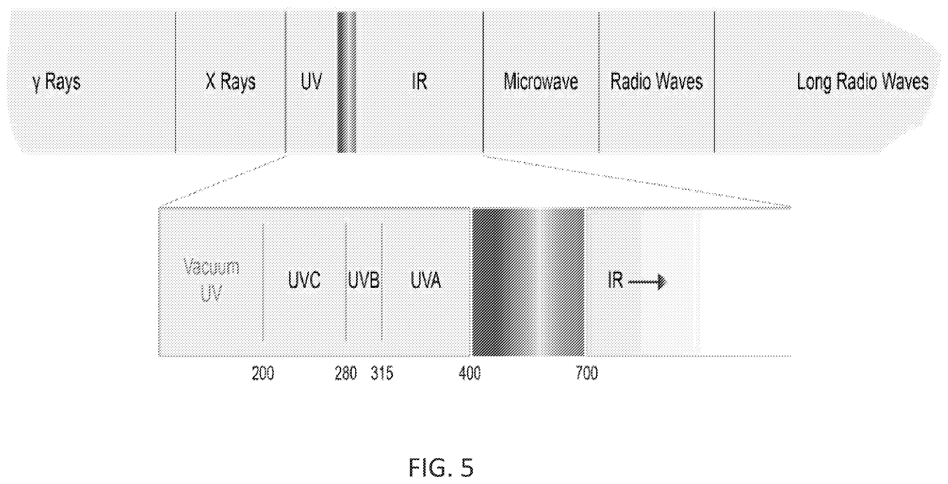

For example, FIG. 4A shows a specific embodiment of the microfluidic device. The embodiment shown in FIG. 4A was assembled using a PET base (11), a film comprising a laser-cut fluidic channel (12), a film comprising a channel outlet (13), a film comprising a vented spacer (14), a crosslinked xanthommatin-based sensor (15) within the vented spacer (14), and an ETFE seal (16) configured to allow light to reach the crosslinked xanthommatin-based sensor (15). When pressure is applied to the oval-shaped button (17) at the beginning of the channel, the fluid is pushed into the paper-based sensor, which is hydrated with cystine solution via capillary action.

### Methods of Making

Also described herein is a method of making a sensor described herein, the method comprising incubating a substrate with a first mixture comprising xanthommatin or a salt thereof in a first solvent, thereby distributing the xanthommatin or a salt thereof throughout the substrate.

In some aspects, the first solvent is an organic solvent. Examples of organic solvents include: alkyl solvents (such as hexanes, cyclohexane, pentanes, and the like), aromatic solvents (such as benzene, toluene, and the like), alcohols (such as acidic methanol, ethanol, and the like), esters, ethers, and ketones (such as diethyl ether, acetone, and the like), amines (such as dimethyl amine and the like), and nitrated and halogenated hydrocarbons (such as dichloromethane, acetonitrile, and the like). In some aspects, the organic solvent is methanol.

In some aspects, the first solvent is MES buffer. In some aspects, the first solvent is dimethyl sulfoxide.

In some aspects, the first mixture further comprises an acid, such as an inorganic acid or organic acid. Examples of acids include any of those cited herein in connection with the description of salts. In some aspects, the acid is hydrochloric acid (HCl).

In some aspects, the first mixture has a pH of less than about 7, e.g., of about 0 to about 7 about 0 to about 6, about 0 to about 5, about 0 to about 4, about 0 to about 3, about 0 to about 2, about 0 to about 1, or less than about 1.

In some aspects, the first mixture further comprises an oxidizing agent. Examples of oxidizing agents include: oxygen, nicotinamide adenine dinucleotide (NAD*), hydrogen peroxide, ozone, halogens (e.g. F₂, Cl₂, Br2, and I₂), oxyanions (e.g. sodium nitrite, sodium hypochlorite, calcium hypochlorite, potassium perchlorate, potassium chlorate, potassium permanganate, ammonium persulfate, sodium persulfate, and potassium dichromate), and oxyacids (e.g. nitric acid, sulfuric acid, and phosphoric acid). In some aspects, the oxidizing agent is sodium nitrite.

In some aspects, the method further comprises crosslinking the xanthommatin or a salt thereof, thereby forming one or more crosslinked derivatives of xanthommatin or a salt thereof crossdistributed throughout the substrate. In some aspects, the one or more crosslinked derivatives of xanthommatin or a salt thereof comprise, consist essentially of or consist of crosslinked xanthommatin, e.g., as when crosslinking is performed using a zero-length crosslinker. In some aspects, the method further comprises crosslinking the xanthommatin or a salt thereof with a crosslinker, e.g., a zero-length crosslinker. Examples of crosslinkers include those described herein. In some aspects, the crosslinker is a zero-length crosslinker, such as EDC.

In further aspects, the crosslinker is dissolved in a buffer solution. In some aspects, the buffer is 2-(N-morpholino) ethanesulfonic acid (MES). In further aspects, the buffer has a pH of about 6.0.

In some aspects, the method further comprises washing the substrate to remove xanthommatin or a salt thereof not distributed throughout the substrate, washing the substrate to uncrosslinked xanthommatin or a salt thereof, or washing the substrate to remove xanthommatin or a salt thereof not distributed throughout the substrate and washing the substrate to remove uncrosslinked xanthommatin or a salt thereof.

In some aspects, the method further comprises drying the substrate comprising xanthommatin or a salt thereof, or drying the substrate comprising crosslinked xanthommatin or a salt thereof, or drying the substrate comprising xanthommatin or a salt thereof and drying the substrate comprising crosslinked xanthommatin or a salt thereof.

In some aspects, the method further comprises wetting a dry sensor or dry substrate comprising xanthommatin or a salt or a crosslinked derivative thereof in a liquid, including any of those described herein in connection with the sensors.

### Uses

Wearable light sensors have been developed in this work based on xanthommatin, a natural and photo-responsive pigment. Previous evaluations of the photochemical properties of xanthommatin have uncovered that the oxidation state of the pigment molecule can undergo transient changes in response to sunlight, resulting in radiation-controlled changes in visible color. Conditions have been identified in which xanthommatin undergoes permanent photoreduction and the resulting dose-dependent colorimetric responses have been leveraged to create disposable wearable radiometers. In the characterization of these sensors, it was discovered that they were not only responsive to the ultraviolet, visible, and near IR wavelengths occurring in natural sunlight, but also changed color in response to UVC radiation. The performance of the sensors has been validated as wearable solar radiometers and mountable indicators of germicidal UVC radiation. By incorporating these sensors into self-contained, button-activated microfluidic devices, they can be packaged as user friendly prototypes. These systems represent an important advancement toward quantitative measurements of solar radiation across multiple biologically relevant spectral regions, without requirements for electronic components or advanced manufacturing strategies.

Current portable electronic meters designed to measure the risk of sunburning are expensive and do not support continuous measurement during outdoor activities. Several film-based prototypes that change color in response to sunlight have been developed as wearable sensors, but these detections strategies are often sensitive to only one form of UV radiation. Skin damage is known to result from the combined effects of multiple spectral regions of solar radiation, including ultraviolet, visible, and infrared wavelengths. At present, miniaturized electronic devices are the only wearable sensors that can measure radiation risk across multiple spectral regions, but these devices are expensive and challenging to manufacture compared to film-based devices.

The approach in this work is unique in that the sensors described herein are functionalized with xanthommatin as the active ingredient, are responsive to both ultraviolet and visible-near IR light, and do not require electronics. These devices are made from laminated paper and plastic films and do not require any specialized microfabrication equipment for manufacturing. The sensors described herein provide a colorimetric output upon irradiation that can be interpreted by eye or by quantitative image analysis. These devices can measure ultraviolet and visible-near IR light to indicate sun safety, and double as qualitative indicators for verifying that lethal doses of UVC have been applied to pathogens during UVC sterilization.

Described herein is the use of any of the sensors described herein as a solar radiometer. Also described herein is the use of a microfluidic device described herein as a solar radiometer. In some aspects, the solar radiometer is wearable.

Also described herein is the use of any of the sensors described herein as a UVC radiation detector. Also described herein is the use of a microfluidic device described herein as a UVC radiation detector. In some aspects, the UVC radiation detector is mountable to a surface.

Other example uses for the sensors described herein include:
Solar light meters, e.g., for skin health/solar exposure awareness; prevention of erythema (e.g., sunburn)
UVC indicator (e.g., stickers/cards), e.g., for germicidal sterilization
Visible light sensors, e.g., for tracking exposure to intense visible light
UVC dosimetry
Monitoring high-intensity visible light

### Exemplification

Overexposure to complete solar radiation (combined ultraviolet, visible, and infrared) is correlated with several harmful biological consequences including hyperpigmentation, skin cancer, eye damage, and immune suppression. With limited effective therapeutic options available for these conditions, significant efforts have been directed toward promoting preventative habits. Recently, wearable solar radiometers have emerged as practical tools for managing personal exposure to sunlight. However, designing simple and inexpensive sensors that can measure energy across multiple spectral regions without incorporating electronic components remains challenging, largely due to inherent spectral limitations of photoresponsive indicators. This work reports the design, fabrication, and characterization of wearable radiation sensors that leverage an unexpected feature of a natural biochrome, xanthommatin-its innate sensitivity to both UV and visible through near-infrared radiation. It was found that xanthommatin-based sensors undergo a visible shift from yellow to red in the presence of complete sunlight. This color change is driven by intrinsic photoreduction of the molecule, which was investigated using computational modeling and supplemented by radiation-driven formation of complementary reducing agents. These sensors are responsive to dermatologically relevant doses of erythemally weighted radiation, as well as cumulative doses of high-energy ultraviolet radiation used for germicidal sterilization. These miniature sensors were incorporated into pressure-activated microfluidic systems to illustrate on-demand activation of a wearable and mountable form factor. When taken together, the findings encompass an important advancement toward accessible, quantitative measurements of UVC and complete solar radiation for a variety of use cases.

The following data has been published in Wilson, D. J.; Martin-Martinez, F. J.; Deravi, L. F., Wearable Light Sensors Based on Unique Features of a Natural Biochrome, ACS Sensors 2022, 7 (2), 523-533, the entire content of which is incorporated herein by reference.

### Example 1: Photochemical Properties of Xanthommatin

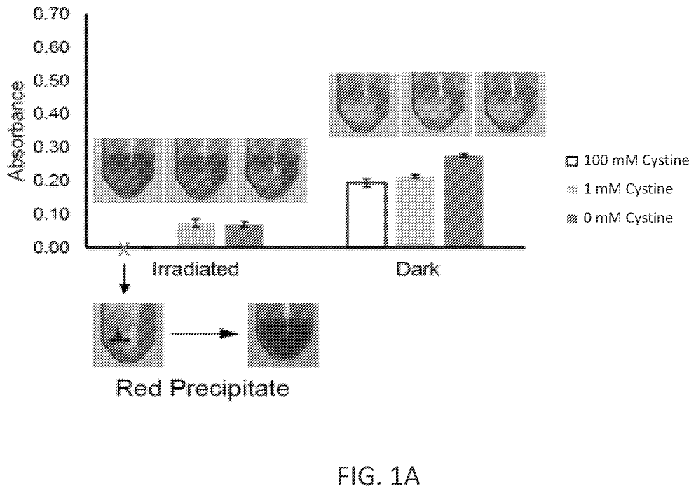

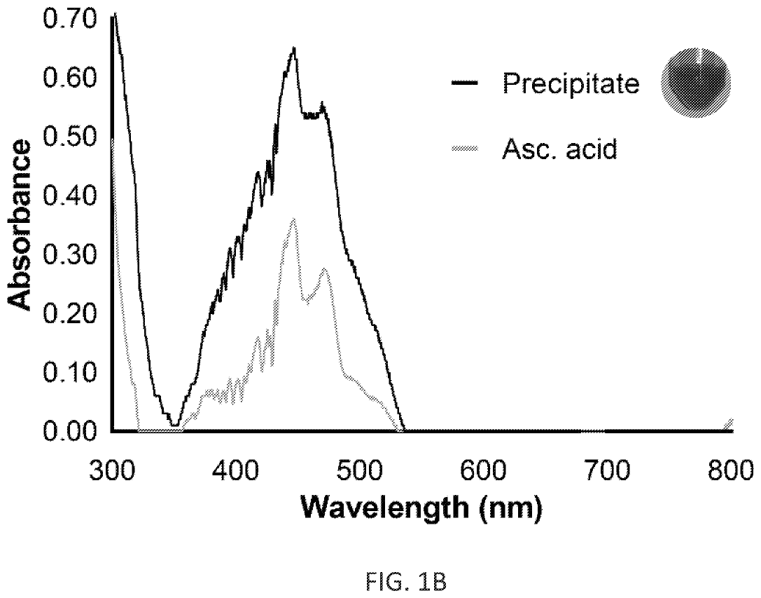

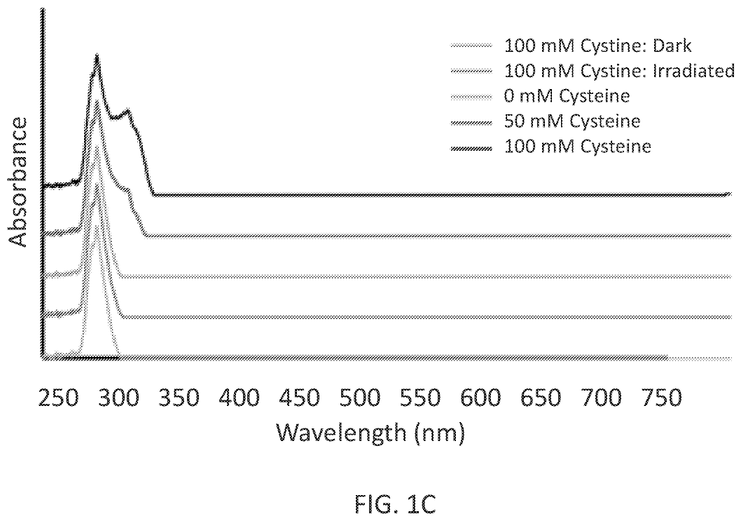

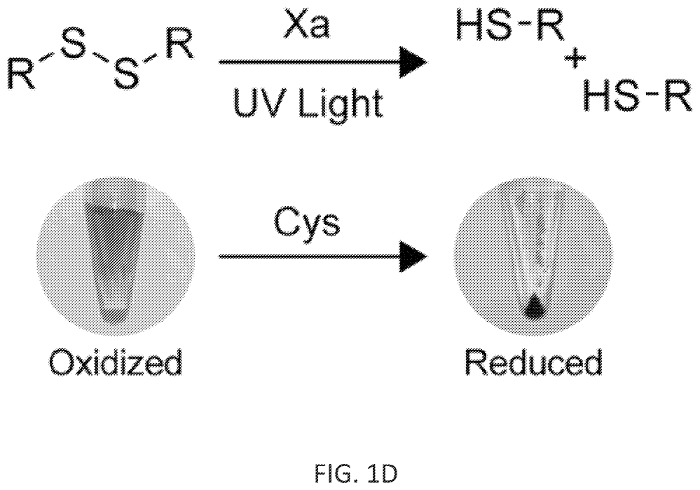

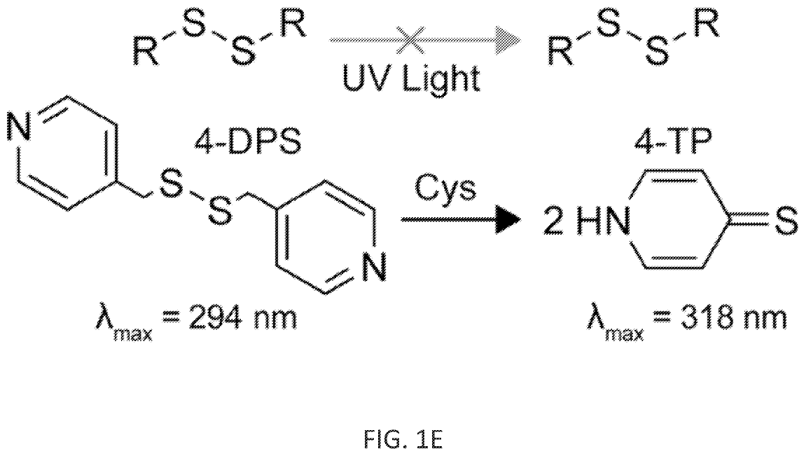

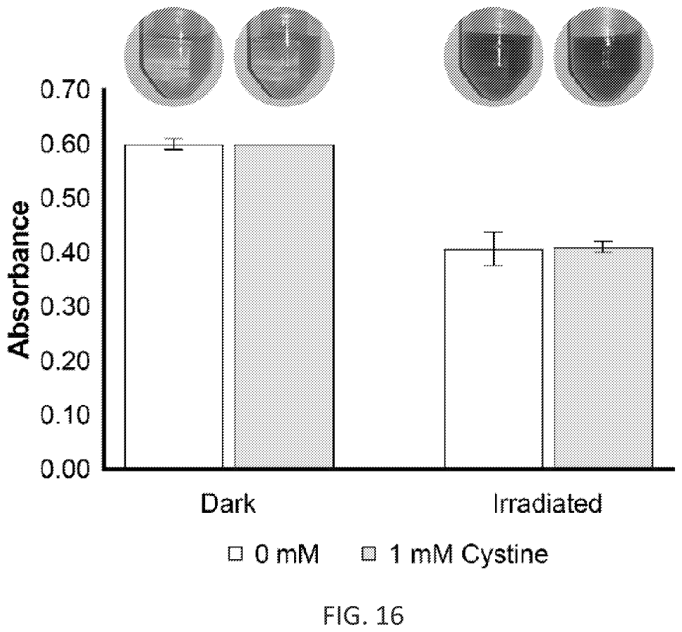

Previous evaluations of photolabile color in ommochrome pigments have been performed in acidic or ionic solvents used to extract the pigments from biological tissues, such as acidic methanol and aqueous solutions of detergent (e.g., cetyltrimethylammoniumbromide, digitonin). In an effort to identify conditions that could support development of wearable sensors, spectrophotometric analyses were performed using xanthommatin dissolved in MES buffered to pH 6 or prepared as an acidified, unbuffered solution (pH<1). Basic conditions were not evaluated, as they are known to destabilize ommatins. After irradiating these solutions with simulated solar light, it was observed that the absorbance maximum of oxidized pigment, occurring at 444 nm, was attenuated in buffered and acidic MES conditions. The visible color of pigment in buffered solutions shifted from a characteristic yellow to dark brown (FIG. 16), and acidified solutions turned a deep red color representative of reduced xanthommatin as depicted in FIG. 6 (FIG. 1A), suggesting that more dramatic colorimetric responses occur in acidified, unbuffered conditions.

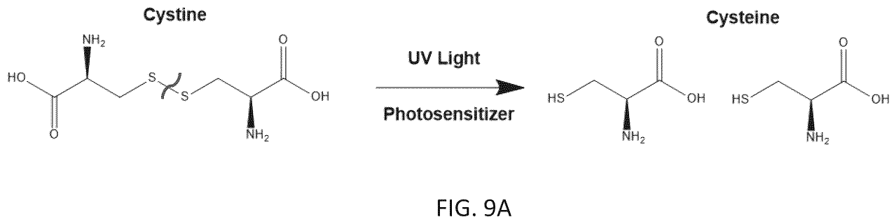

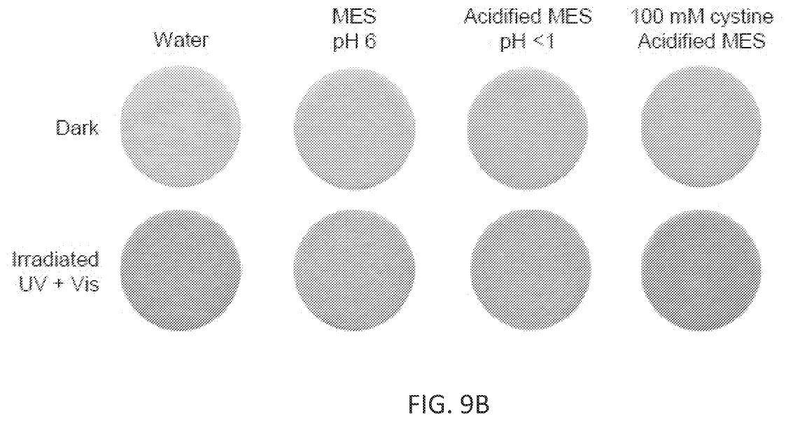

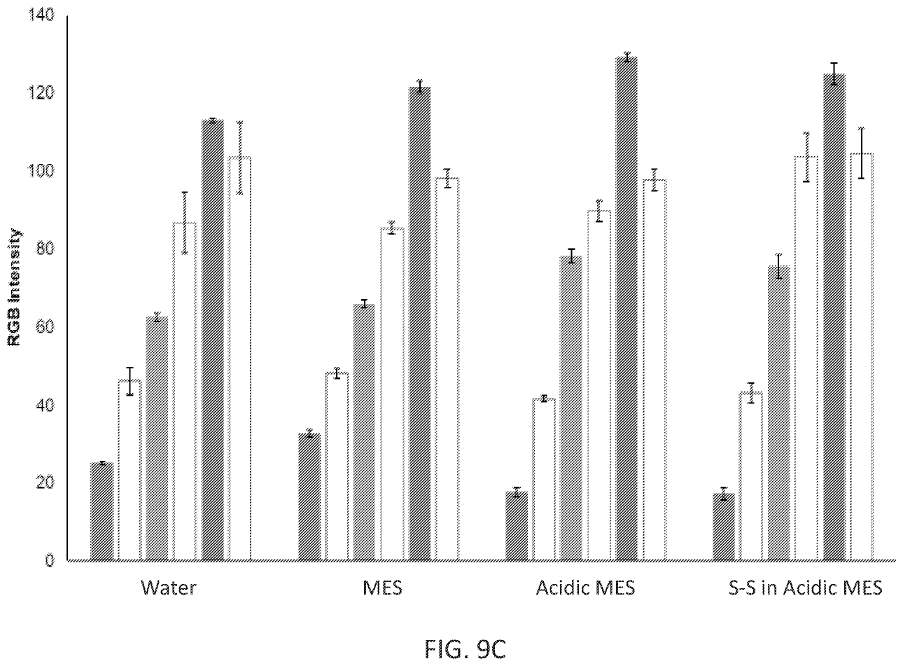

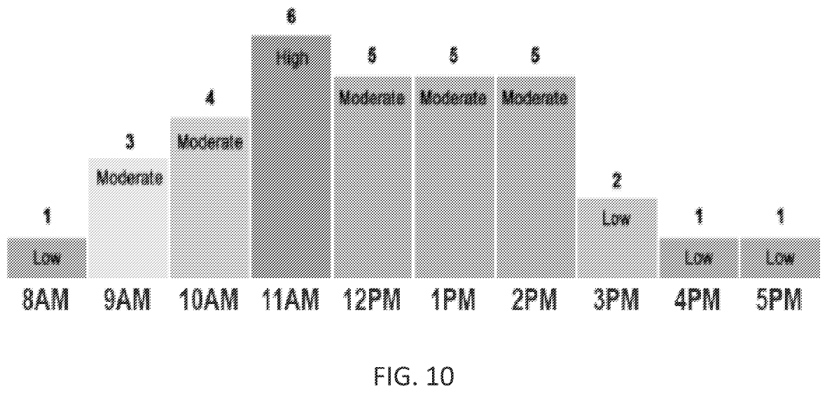

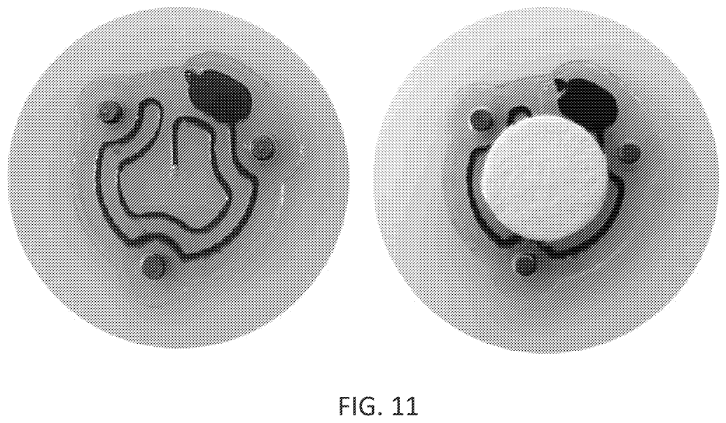

While this color shift was visibly obvious, one goal was to explore the possibility of incorporating additional reagents that could form reducing agents upon irradiation as a means of enhancing the accessible color range and analytical performance of xanthommatin-based radiation sensors. Recent characterizations of UV-induced protein degradation have revealed that tryptophan acts as a photosensitizer to facilitate radiative cleavage of disulfide bonds (FIG. 9A) and liberate thiols. It was hypothesized that xanthommatin, a tryptophan derivative, could enable conversion of disulfide bonds to free thiols, resulting in further reduction of the pigment and formation of a rich red color. It was observed that cysteine was an effective reducing agent for xanthommatin, yielding a red precipitated pigment (FIG. 1D).

To assess whether radiation-driven formation of free thiols, enabled by the photochemical properties of xanthommatin, could enrich the observed red color of the irradiated pigment, the disulfide cystine was added to acidified solutions of xanthommatin subjected to simulated solar light. In acidic solutions containing equimolar pigment and cystine, the oxidized dimer of the amino acid cysteine, there was no observable color enhancement. However, irradiation of pigment and excess cystine (1:100) resulted in complete attenuation of absorbance at 444 nm, concurrent with precipitation of a red solid (FIG. 1A) characteristic of xanthommatin treated with free cysteine. The precipitate was solubilized using acidic methanol and its absorbance spectrum was compared to that of xanthommatin reduced with ascorbic acid (1:1). It was observed that both solutions had absorbance peaks characteristic of reduced xanthommatin around 480 nm (FIG. 1B). This precipitate was not observed in cystine-containing samples stored in darkness. To confirm that precipitation of reduced xanthommatin was caused by formation of free cysteine, 4,4′-DPS, which is converted to chromogenic 4-thiopyridone (4-TP) by free thiols, was used to measure the concentration of cysteine in irradiated solutions of cystine (FIG. 1E) and confirm that free thiols were not generated upon irradiation of solutions that did not contain xanthommatin (FIG. 1C), suggesting that this tryptophan-derived pigment acted as a photosensitizing agent for disulfide bonds and was reduced by free thiols upon formation of cysteine in initial experiments.

### Example 2: Sensor Design, Fabrication, and Performance

In the spectrophotometric analysis of xanthommatin photoreduction in solution, it was found that colorimetric responses to sunlight were enhanced by radiation-induced formation of cysteine in acidic environments. Miniature crosslinked xanthommatin-based radiometers with uniform distributions of dose-dependent color were fabricated using carbodiimide chemistry to create crosslinked networks of xanthommatin throughout the porous architecture of round punches of chromatography paper. This established strategy of immobilizing colorimetric reagents in an inexpensive, patternable substrate provided planar sensors functionalized with fully oxidized pigment. The substrates were hydrated with a 100 mM solution of cystine in acidified MES and laminated between adhesive-backed plastic films to mitigate evaporation during irradiation. The top layer of each laminated assembly was either a UV-transmitting ETFE film or a UV-blocking polyester film to include or exclude, respectively, energy from ultraviolet wavelengths (FIG. 2A). The sensors were subjected to controlled doses of UVA (365 nm), UVB (302 nm), UVC (254 nm), and visible-near IR (400-1100 nm) radiation. Sensors stored in darkness remained yellow, while irradiated sensors shifted to a red color over time. Development of a red color concurrent with increasing doses of cumulative radiation over time was qualitatively observed. At a cumulative dose of 1 J cm-2 for each ultraviolet wavelength, sensors showed increasing red color and decreasing measured values of yellow chromaticity with higher-energy wavelengths. Quantitative measurements of sensor chromaticity were performed by acquiring high-resolution images of sensors under consistent lighting and color conditions using a flatbed scanner (Example 13). Interestingly, cystine-containing sensors showed enhanced color shifts over sensors treated with acidified MES solution only for irradiations performed with UVB and UVC radiation. No such enhancement was observed in devices irradiated with UVA (FIG. 2B). Sensors sealed with a UV-blocking film showed no response to equivalent doses of ultraviolet light but shifted up to 17 chromaticity units as the sensors became visibly red upon irradiation with 20 J cm-2 of 400-1100 nm solar-simulated light, highlighting the performance of xanthommatin as a wavelength-specific photosensitive indicator across doses spanning orders of magnitude (FIG. 2C).

### Example 3: Measurements of Erythemal and Germicidal Ultraviolet Radiation

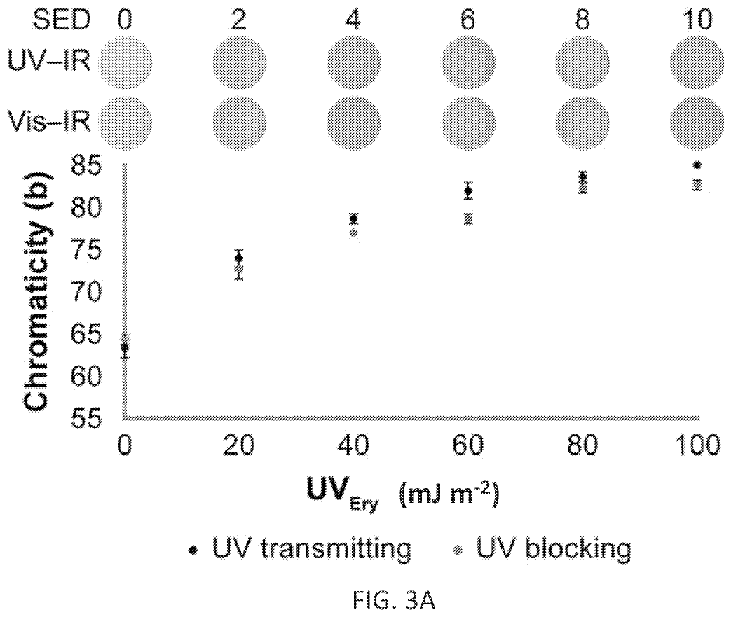

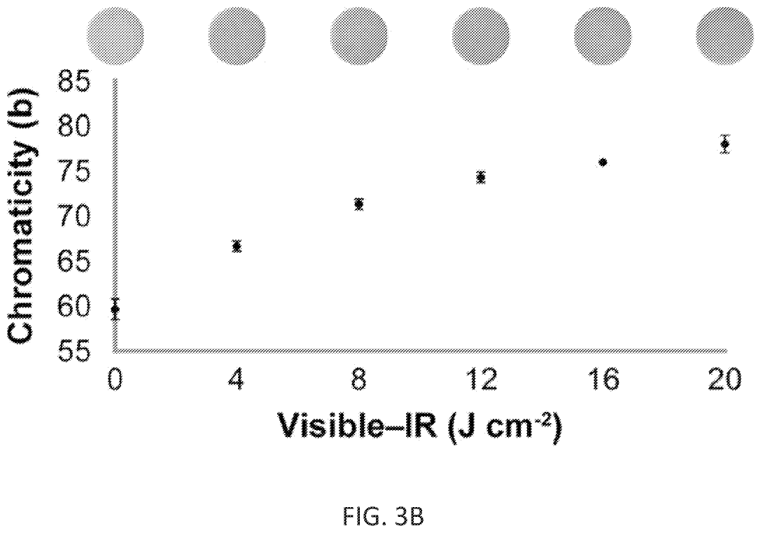

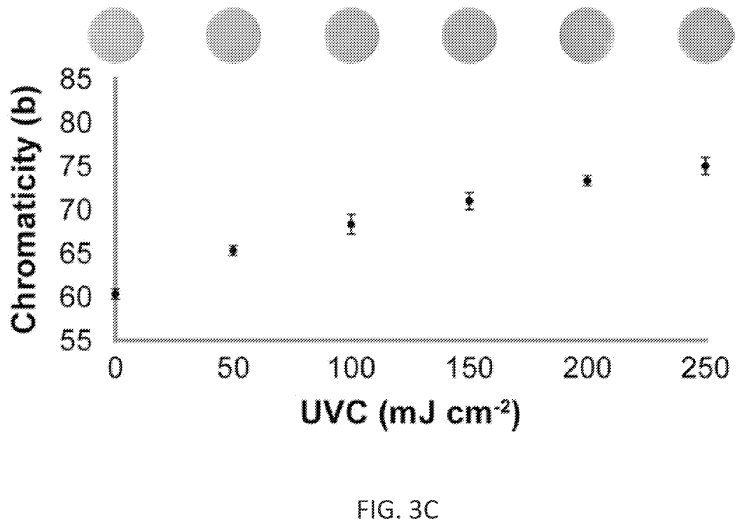

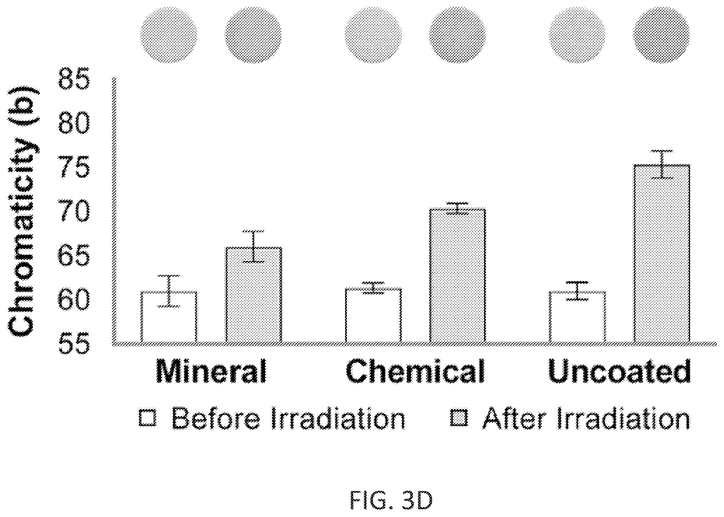

The utility of the sensors was assessed as wearable dosimeters for solar exposure by administering controlled doses of erythemally weighted UV radiation in natural sunlight outdoors. To perform these experiments, the approximate value of UV_{Ery} was calculated from the forecasted hourly UV index for Burlington, Massachusetts, where the experiments were performed, and controlled irradiation times to achieve a range of cumulative standard erythemal doses. Color differences between sensors stored in darkness and sensors subjected to low doses of erythemal radiation indicated that these devices enabled visual determination of cumulative doses that can lead to skin damage in fair skin types. Red signals produced by higher doses of erythemal radiation showed obvious photoreduction but approached saturation with increasing cumulative energy. While these responses were more challenging to interpret by visual inspection, they could be differentiated by measured chromaticity values (FIG. 3A). During this dose-controlled evaluation of sensor responses to UV_{Ery}, devices prepared with a UV-blocking barrier to assess the relative contributions of UV and visible-near IR radiation were also irradiated. These sensors achieved smaller changes in chromaticity than those subjected to complete solar radiation, which confirmed that photoreduction of crosslinked xanthommatin in these assemblies resulted from combined contributions of ultraviolet and visible-IR energies. Although there are not erythemal weighting functions for visible or infrared light, evaluation of sensors irradiated with controlled doses of 400-1100 nm radiation (FIG. 3B) highlighted important differences in the quantities of energy required to elicit measurable sensor responses across spectral regions, and demonstrated that these sensors can be outfitted with simple optical filters to suit a variety of applications.

While it was expected that the sensors undergo photoreduction in response to ultraviolet wavelengths found in terrestrial solar light, it was observed that they were also sensitive to UVC radiation. Irradiation with high-energy UV light can be an effective method of sterilizing surfaces and air to protect against pathogens and is also used for preservation and enhancement of food products. With these applications in mind, another goal was to explore whether the wearable solar dosimeters could double as surface-mounted indicators for threshold doses of germicidal irradiation. Because reported doses of UVC radiation required to yield effective (e.g., 3 log 10) reduction of pathogens vary considerably, benchmark doses ranging from 25-1000 mJ cm-2 measured by single-use dosimetry cards are useful for ensuring that lethal doses for common pathogens are exceeded in critical settings, such as hospitals. The sensors were used to measure doses of UVC radiation up to 250 mJ cm-2 (FIG. 3C), which was achieved within minutes using a standard handheld lamp and demonstrated that these sensors can also function as qualitative visual indicators for doses of radiant energy lethal to hazardous pathogens.

Devices coated with thin films of sunscreen using natural sunlight were also irradiated. While these films were not controlled for thickness, chromaticity differences of 5, 9, and 14 units were observed for devices coated with mineral sunscreen, chemical sunscreen, or no sunscreen, respectively, before and after irradiation (FIG. 3D). These results indicated that sensor responses may be attenuated by using these wearable devices with photoprotective filters designed to scatter or absorb UV radiation, highlighting the compatibility of the sensors with existing best practices for preventing solar overexposure.

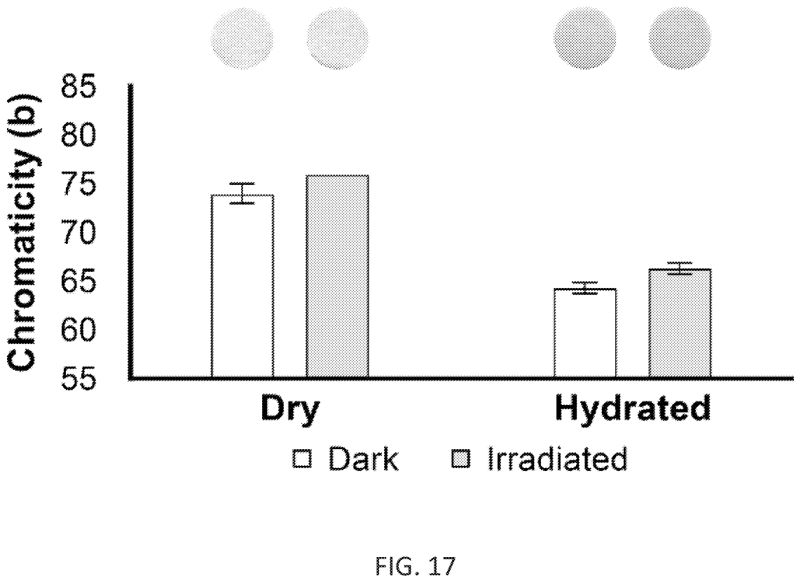

Because the irradiance of indoor fluorescent lighting is orders of magnitude lower than that of natural sunlight, the doses of visible-near-IR energy required to elicit a visually obvious response from the sensors indoors are not achieved over reasonable device use periods. In outdoor experiments, the measured visible—near-IR irradiance (400-1100 nm) of natural sunlight was 90 mW cm⁻² and began to shift sensor color within minutes, while the measured irradiance of indoor lighting was 5×10⁻³ mW cm⁻² and did not provide an appreciable color change in dry or hydrated sensors over the course of 3 hours (FIG. 17). Under the assumption that visible-near-IR irradiance scales with the UV index and UV_{Ery} intensity, sensors outfitted with either UV-transmitting or UV-blocking filters should both enable users to monitor exposure to complete solar radiation with the understanding that these devices are intended for outdoor use. However, a specific optical filter and device architecture may be selected to limit sensing to a target spectral region. To further explore sensor responses to high-intensity visible—near-IR light, the color change was evaluated using controlled doses of 400-1100 nm radiation (FIG. 3B) and again observed that without contributions from UV wavelengths, high doses of visible-near-IR energies are required to generate responses that span the accessible color range provided by xanthommatin. While there are no erythemal weighting functions for visible or infrared light, these observations highlight fundamental differences in sensor performance across multiple spectral regions, demonstrating that these sensors can be outfitted with simple optical filters to suit a variety of applications.

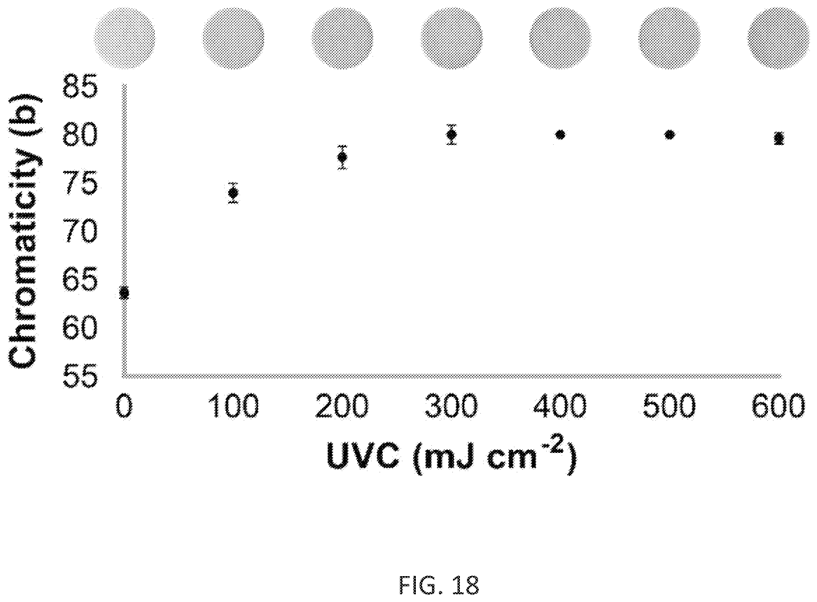

While it was expected that the sensors undergo photoreduction in response to UV wavelengths found in terrestrial solar light, it was observed that they were also sensitive to UVC radiation. Irradiation with high-energy UV light can be an effective method of sterilizing surfaces and air to protect against pathogens and is also used for preservation and enhancement of food products. With these applications in mind, it was then explored whether the wearable solar dosimeters could double as surface-mounted indicators for threshold doses of germicidal irradiation. Because the reported doses of UVC radiation required to yield effective (i.e., 3 log 10) reduction of pathogens vary considerably, benchmark doses ranging from 25 to 1000 mJ cm⁻² measured by single-use dosimetry cards are useful for ensuring that lethal doses for common pathogens are exceeded in critical settings, such as hospitals. The sensors were used to measure doses of UVC radiation up to 250 mJ cm⁻² (FIG. 3C), achieved within minutes using a standard handheld 254 nm lamp, to demonstrate that these sensors can also function as qualitative visual indicators for doses of radiant energy lethal to hazardous pathogens, such as Candida auris (103-192 mJ cm⁻²), Escherichia coli (6-13 mJ cm⁻²), and SARS-CoV-2 (4-17 mJ cm⁻²). It was found that the colorimetric signals provided by the sensors saturated for doses of 300 mJ cm⁻² and higher (FIG. 18) and no photobleaching or additional color change was observed with prolonged exposure to high-energy radiation. Based on the spectrophotometric analysis of xanthommatin irradiated in acidic conditions with excess cystine, in which it was observed that precipitation of reduced pigment, which is believed that local precipitation of reduced xanthommatin within the porous microstructure of the paper sensor substrate may protect the functional component of these devices from degradation.

### Example 4: Computational Analysis of Xanthommatin Reactivity and Photochemistry

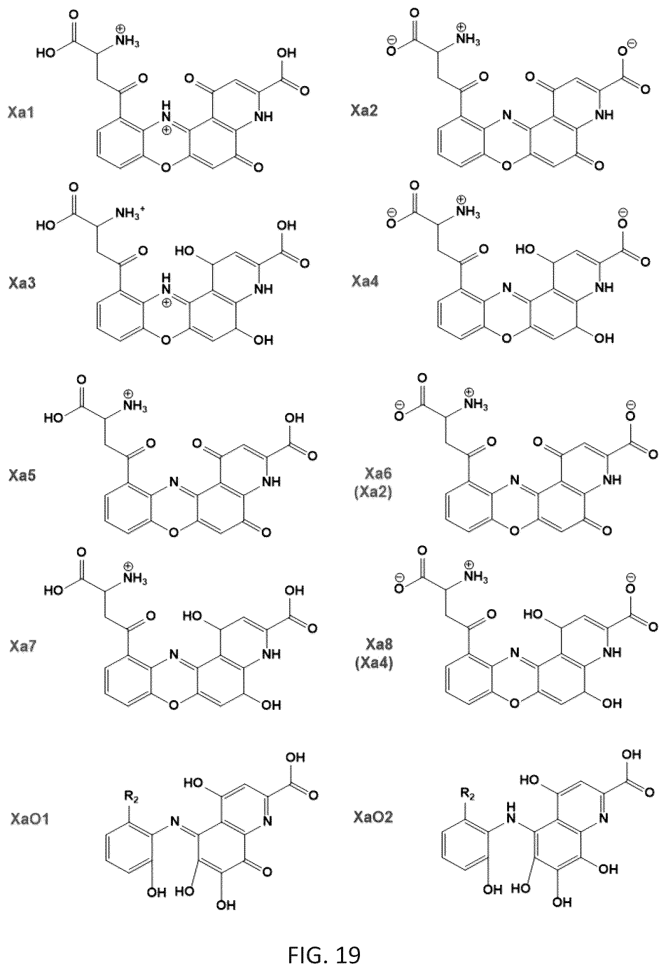

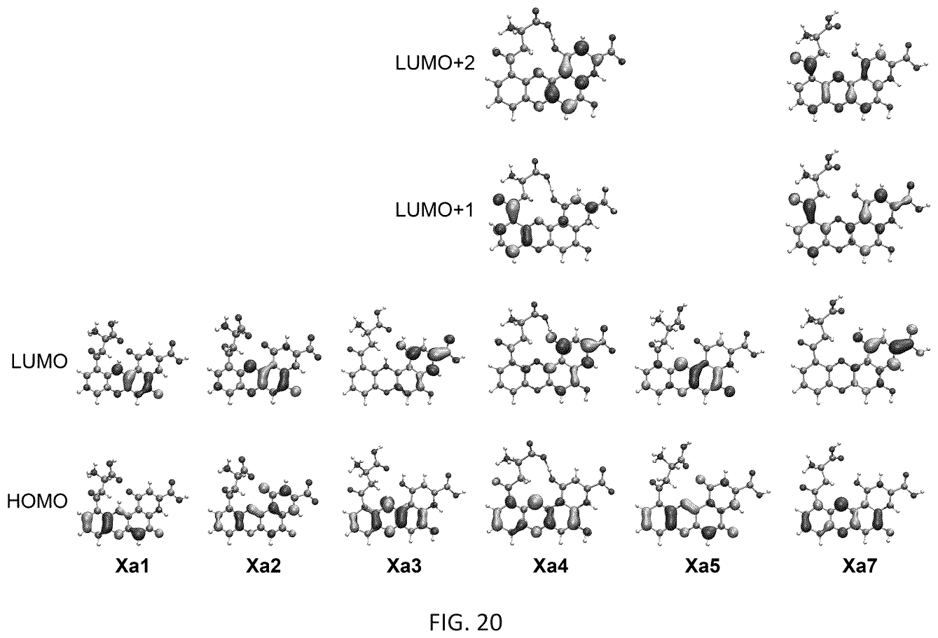

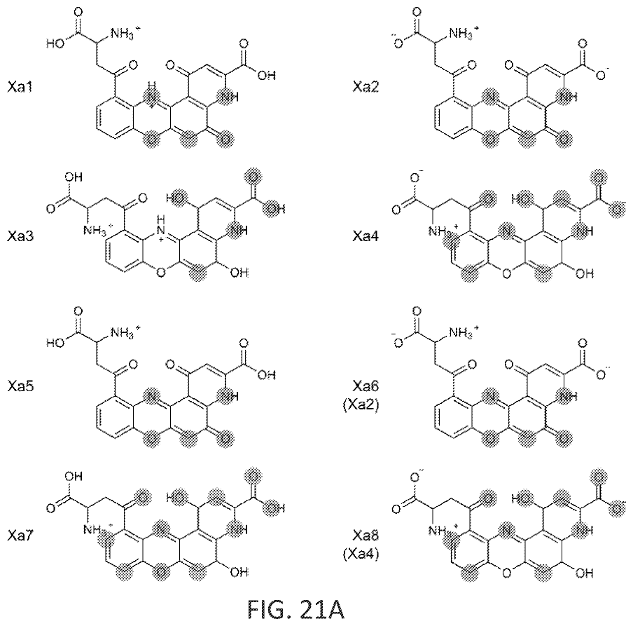

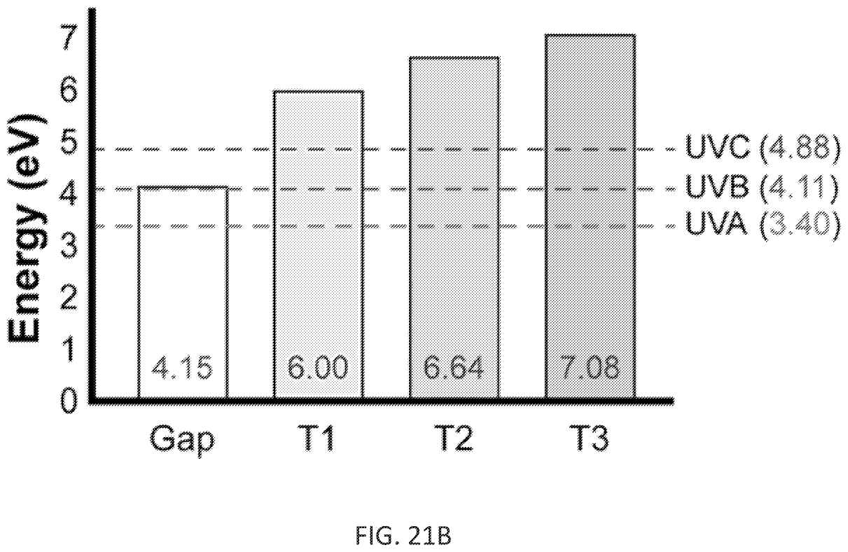

To further explore these unexpected, intrinsic photochemical properties of xanthommatin and its performance in wearable sensors, computational molecular models of the predicted structures for both oxidized and reduced forms of protonated and deprotonated xanthommatin were developed and density functional theory (DFT) calculations were performed. The reactivity of several protonation and oxidation states of xanthommatin (FIG. 19) were performed using the global chemical hardness, a conceptual DFT reactivity descriptor that indicates the tendency of any given molecules to transfer electrons upon a chemical reaction. Generally, low chemical hardness values (i.e., higher tendency to get engaged into chemical reactions) were observed for oxidized, protonated structures (Table 1), supporting the experimental observations that acidic conditions can promote the photochemical reduction of xanthommatin. Additionally, a frontier orbital analysis was performed and the electron transitions and energy gaps involving the highest occupied molecular orbital (HOMO) and lowest unoccupied molecular orbital (LUMO, FIG. 20) were calculated to assess the possible excited states of these structures upon stimulation with UVA, UVB, and UVC radiation (Table 2). In the DFT calculations, it was observed that higher-energy UV radiation increases the number of achievable electronic transitions (Table 3) and possible atomic positions where xanthommatin could react with secondary species in the surrounding environment (FIG. 21). It was also observed that radiation energies greater than energy gap thresholds specific to each possible xanthommatin structure could excite electrons from the HOMO to the LUMO, but that the allowed transitions were dependent on molecular structure (FIGS. 19 and 21A-B, and Tables 2 and 3). These computational results are supported by the experimental findings, which showed the greatest color shift in xanthommatin-based sensors subjected to UVC radiation. Photosensitization of cystine by tryptophan has been demonstrated using UVB radiation. Interestingly, enhancement of photoreduction in cystine-treated sensors irradiated with UVB or UVC was observed, but not UVA (FIGS. 2A-C). While these calculations begin to establish an understanding of how irradiation energy dictates when and where xanthommatin is susceptible to reactions with secondary species, they do not explain the relative contributions of intrinsic vs extrinsic photoreduction.

TABLE 1
Chemical hardness values calculated for xanthommatin
structures depicted in FIG. 19.

| | Charge | Multiplicity | IE (eV) | EA (eV) | Hardness |
|---|---|---|---|---|---|
| Xa1 | 2 | 1 | 7.35 | 4.87 | 1.24 |
| Xa2 | −1 | 1 | 6.58 | 3.52 | 1.53 |
| Xa3 | 2 | 1 | 5.73 | 3.47 | 1.13 |
| Xa4 | −1 | 1 | 4.03 | 2.25 | 0.89 |
| Xa5 | 1 | 1 | 7.09 | 3.77 | 1.66 |
| Xa6 (Xa2) | −1 | 1 | 6.58 | 3.52 | 1.53 |
| Xa7 | 1 | 1 | 4.31 | 3.08 | 0.62 |
| Xa8 (Xa4) | −1 | 1 | 4.03 | 2.25 | 0.89 |
| XaO1 | 1 | 1 | 6.15 | 3.59 | 1.28 |
| XaO2 | 1 | 1 | 5.68 | 2.09 | 1.80 |

TABLE 2
Energies of UV light sources corresponding to energy gaps for electronic
transitions listed in Table 3 and the atomic positions at which
xanthommatin is susceptible to reactions with secondary species
in the surrounding environment depicted in FIG. 21A.

| | λ (nm) | E (eV) |
|---|---|---|
| UVA | 365 | 3.40 |
| UVB | 302 | 4.11 |
| UVC | 254 | 4.88 |

TABLE 3
Energy gaps of electronic transitions for xanthommatin structures depicted
in FIG. 20 and FIG. 21A. Typographical emphasis corresponding to atomic positions
marked in FIG. 21A are based on whether energy of incident radiation in Table
2 exceeds energy gap magnitude. Underlined indicates UVA (365 nm), italics
indicates UVB (302 nm), and bolded indicates UVC (254 nm). Electronic transitions
enabled by lower radiation energies are also supported by higher radiation
energies (i.e., bold values indicate UVA, UVB, and UVC; italics values indicate
UVA and UVB; underlined values indicate UVA only).

| | Xa1 | Xa2 | Xa3 | Xa4 | Xa5 | Xa6 | Xa7 | Xa8 |
|---|---|---|---|---|---|---|---|---|
| HOMO | −8.21 | −7.18 | −6.54 | −4.88 | −7.48 | −7.18 | −5.17 | −7.18 |
| LUMO | −4.06 | −2.71 | −2.63 | −1.42 | −2.97 | −2.71 | −2.22 | −2.71 |
| LUMO + 1 | −2.21 | −0.81 | −1.59 | −0.63 | −1.59 | −0.81 | −1.18 | −0.81 |
| LUMO + 2 | −1.58 | −0.56 | −1.40 | −0.20 | −1.08 | −0.56 | −0.64 | −0.56 |
| LUMO + 3 | −1.13 | −0.04 | −0.23 | 0.60 | −0.45 | −0.04 | 0.28 | −0.04 |
| GAP (eV) | 4.15 | 4.47 | 3.92 | 3.46 | 4.51 | 4.47 | 2.94 | 4.47 |
| T1 (eV) | 6.00 | 6.37 | 4.95 | 4.25 | 5.89 | 6.37 | 3.99 | 6.37 |
| T2 (eV) | 6.64 | 6.62 | 5.14 | 4.68 | 6.39 | 6.62 | 4.53 | 6.62 |
| T3 (eV) | 7.08 | 7.14 | 6.31 | 5.49 | 7.03 | 7.14 | 5.45 | 7.14 |

### Example 5: Push-Activated Microfluidic Sensor Systems

To package the sensors in user-friendly devices that could be activated immediately prior to use, the design of the initial multilayered sensor assemblies was expanded on to create a microfluidic network for delivering cystine solution to wet or dry crosslinked xanthommatin-based sensors on-demand (FIG. 4A). Paper-based analytical systems have the advantage of being inherently self-metering and can autonomously fill by capillary action and paper has previously been paired with microfluidic channels patterned in laminated plastic assemblies to create composite devices with enhanced flow rates. To investigate whether similar fluidic features could be added to these wearable light sensors to aid the user experience and potentially extend the sensor shelf life, the initial sensor design was expanded to create a push-activated microfluidic network to deliver the activating cystine solution to the capillary volume of the sensor before use (FIG. 4D). Laser-cut features were patterned in the plastic films that comprised the laminated assembly surrounding each paper sensor (FIG. 4A), which created a serpentine microfluidic channel that terminated with an outlet directly beneath each sensor substrate. The beginning of each channel featured an oval-shaped fluid reservoir that served as a pressure-sensitive button for driving cystine solution into the sensor above each channel outlet, with a vent port adjacent to each sensor allowing air to escape from the laminated assembly during capillary wetting. The vent ports were covered with a removable adhesive tab to mitigate evaporation of the cystine solution prior to device use. In these devices, pressure applied at the channel “button” caused the cystine solution front to traverse the remaining distance to the sensor substrate. After the fluid front contacted the paper sensor, fluid was drawn into the paper and distributed radially until the paper was fully saturated. Accordingly, the activation force of these devices was tuned by controlling the volume of solution used to fill the serpentine channel-larger volumes resulted in smaller distances between the solution front and sensor surface, which resulted in lower activation forces, while smaller volumes increased this distance and required greater activation forces (FIG. 4B).

These devices are intended to be activated by user-initiated hydration of the sensor immediately before use so that the stored xanthommatin may facilitate the conversion of cystine to cysteine in acidic conditions, supporting the photoreduction of the pigment and enhancing signal formation upon irradiation. To protect the sensor from irradiation before use, these devices could be stored in light-blocking packaging (e.g., foil pouches) for use in a “real” scenario.

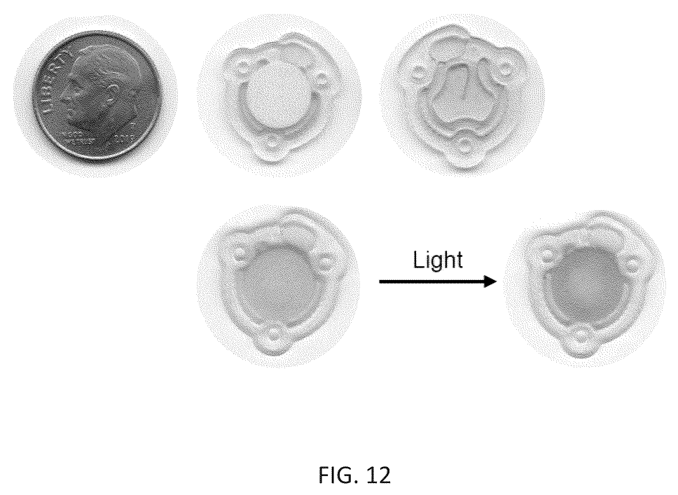

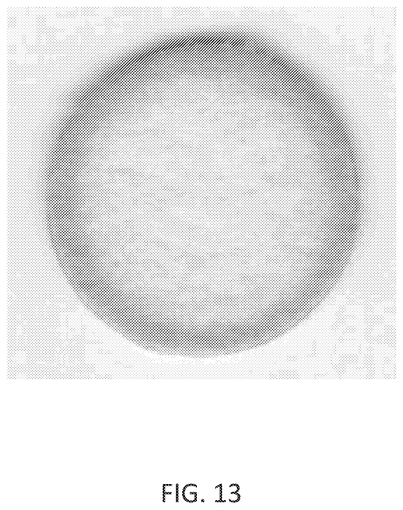

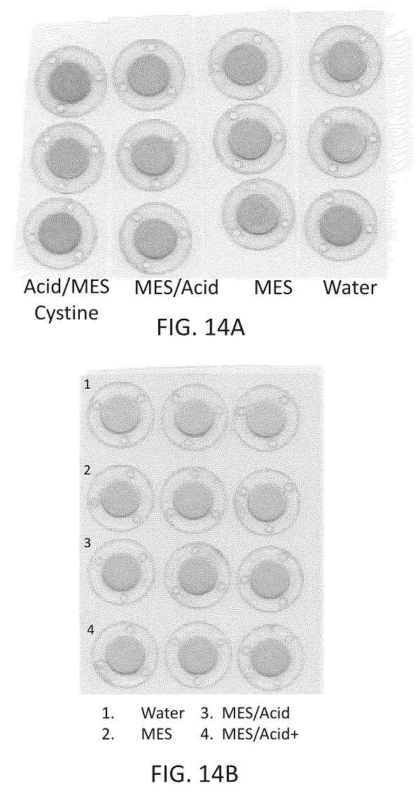

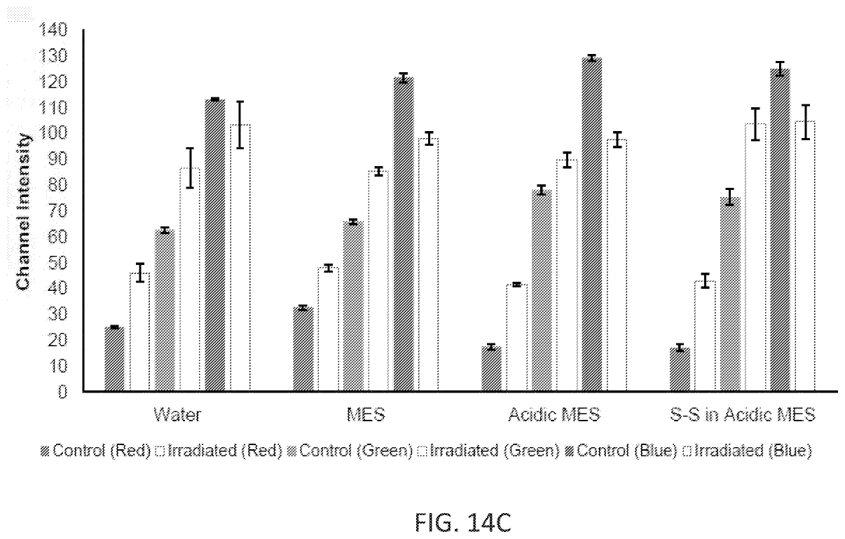

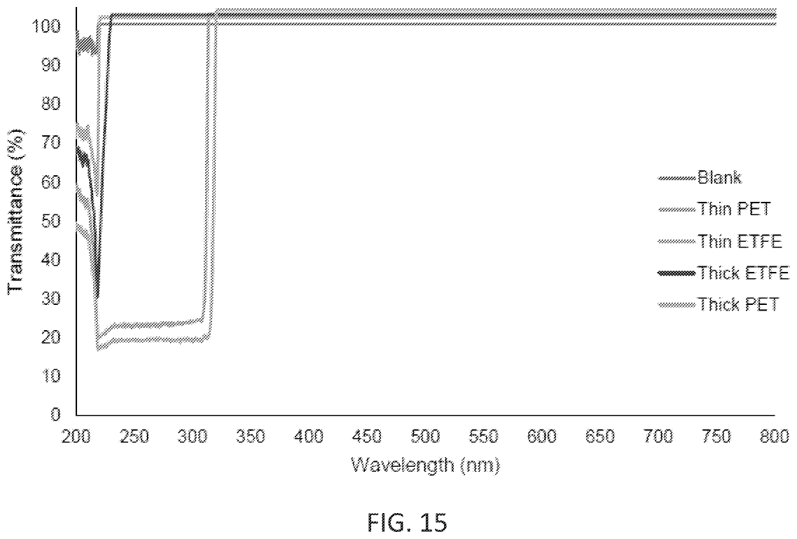

Because the amount of force required to activate these devices (200-500 mN) is determined by the distance that the fluid front must travel to contact the paper-based sensor, the amount of force required to activate these devices was able to be tuned by controlling the volume of solution used to fill the serpentine channel-larger volumes resulted in smaller distances between the solution front and sensor surface, resulting in lower activation forces, while smaller volumes increased this distance and required greater activation forces (FIG. 4C). This approach allowed for the creation of functional, self-contained prototypes that allow the user to hydrate a dry sensor immediately before use (FIG. 12), eliminating requirements for supplemental tools (e.g., pipettes) or operator training and enabling design and fabrication of force-controlled microfluidic systems tailored to specific user requirements or applications. These devices can be qualitatively interpreted by visual inspection and could be paired with accessible imaging technologies (e.g., smartphones) for streamlined quantitative analysis of sensor chromaticity with protocols for calibrating color and lighting across imaging conditions.

This approach allowed for the creation of self-contained prototypes that eliminated requirements for supplemental tools (e.g., pipettes) or operator training, and enabled design and fabrication of force-controlled microfluidic systems tailored to specific user requirements or applications.

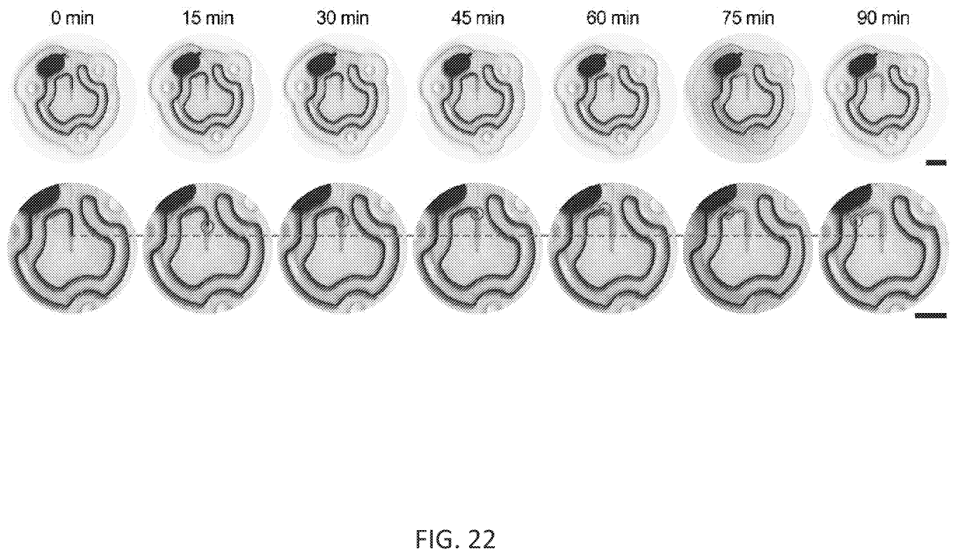

By leveraging the intrinsic photochemical properties of xanthommatin and supplementing radiation-driven color changes using reducing agents generated in response to light, wearable sensors for monitoring radiation were developed in a variety of use cases, including personal solar dosimetry and germicidal sterilization. These miniature radiometers are not limited to a single spectral region or measurement application but can be packaged to quantify independent or combined doses from wavelengths spanning UV-near-IR using a single colorimetric reporter, without requirements for photodiodes or other electronic components. By incorporating these sensors into user-friendly microfluidic devices, the first step has been taken toward leveraging the photochemical properties of xanthommatin to develop deployable systems that could be used to measure radiation exposure on-demand. However, it is important to note that in these devices, hydration of the paper-based sensor is dependent on gas-permeable ports at the beginning of the microfluidic channel and outside of the sensor area. Fully closing either orifice in the device impedes fluid flow by (i) creating a vacuum behind the fill port as capillary action draws fluid into the sensor or (ii) creating pressure in the void volume surrounding the sensor because there is no path for air to escape as it is displaced from the paper during filling. As a result, these devices are susceptible to evaporation during storage (FIG. 22), which will impact the amount of pressure required to activate the device or render the device unusable within short storage periods (e.g., 24 hours). However, this shortcoming could be mitigated by humidifying the devices during storage or incorporating a destructible seal over the device ports that prohibits evaporation during storage but is crushed and permeabilized when the device is activated. Additionally, future iterations of this prototype could incorporate a selectively opened opaque device architecture to enable discrimination between radiation sources across environments (e.g., indoor versus outdoor use) or an integrated color standard to facilitate calibration during image analysis. While there are some challenges that currently preclude consideration of these self-contained devices as shelf-stable commercial products, initial evaluations of xanthommatin-based sensors for complete solar light and germicidal doses of UV radiation highlight the utility of this unique material for the development of colorimetric radiation sensors.

### Example 6: Synthesis of Xanthommatin

The biochrome xanthommatin was synthesized by oxidative cyclization of the precursor 3-hydroxykynurenine (3OHK) using a modification of previously described procedures. 8 mg of 3OHK was dissolved in 2 mL of 25 mM sodium hydroxide, and 33 mg of potassium ferricyanide dissolved in deionized water was added dropwise, which shifted the color of the reaction mixture from yellow to orange. The reaction mixture was covered to exclude light, and a dark brown reaction mixture was observed after 90 minutes of stirring at room temperature. The reaction product precipitated upon dropwise addition of 1 M hydrochloric acid. The dark brown precipitate was washed with cold deionized water followed by centrifugation, and fractions of the washed product were stored at 4° C. until further use.

### Example 7: Spectrophotometric Characterization of Xanthommatin Photochemistry

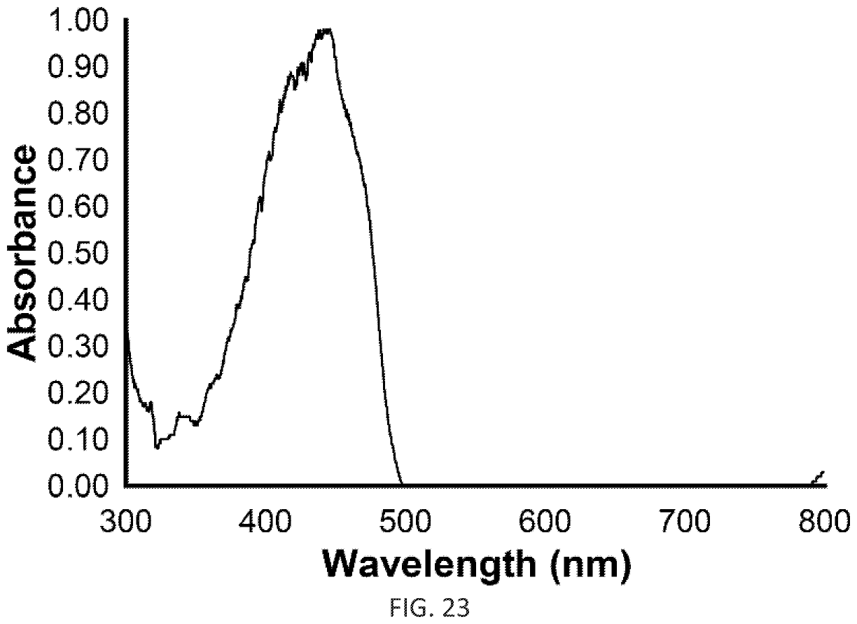

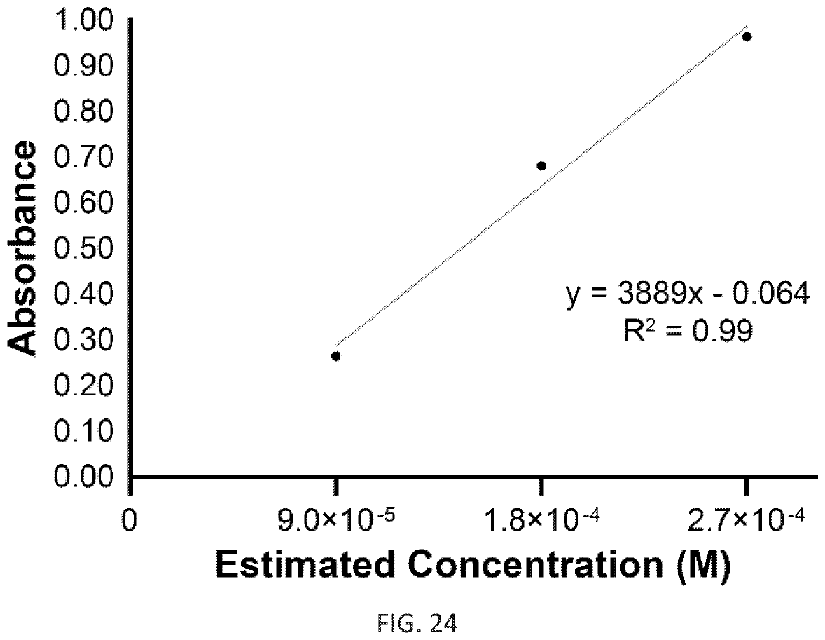

After dissolving the synthesis product in MES buffer (50 mM, pH 6.0), the absorbance of three dilutions of the resulting solution was measured at 444 nm, as was the absorbance maximum of xanthommatin (FIG. 23), to determine the extinction coefficient of the phenoxazine-based chromophore in the stock solution (FIG. 24).

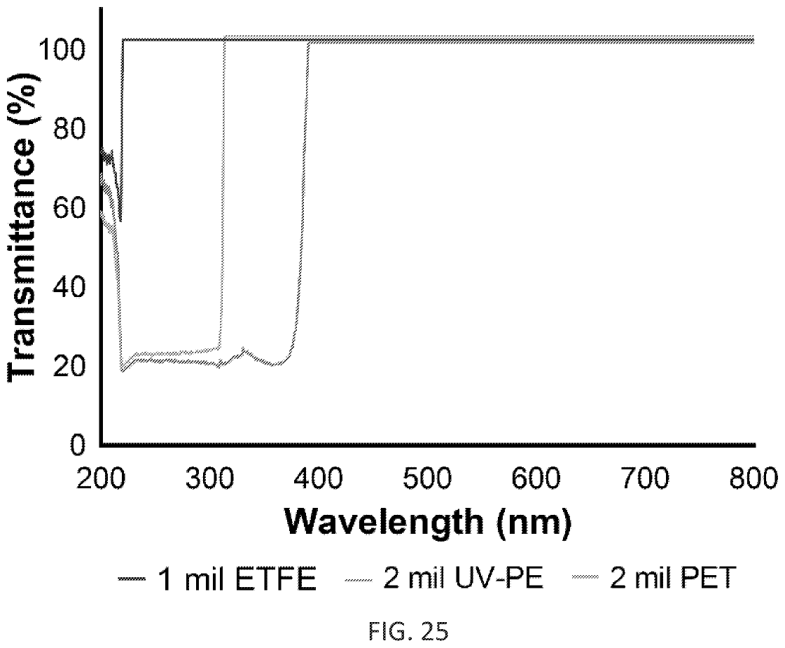

To simulate exposure to sunlight, microcentrifuge tubes containing 300 μL of the xanthommatin solution diluted to 1 mM with buffered or acidified solutions of cystine were irradiated using an arc lamp solar simulator (MKS Instruments, Newport Corporation) calibrated to provide irradiance of 119 mW cm⁻² over a spectral range of 400-1100 nm, equivalent to the irradiance of one sun. The open tubes were covered with an optically transparent, UV-transmitting ETFE (0.001 in thick, McMaster-Carr, FIG. 25) to mitigate evaporation, and the solutions were irradiated for 90 minutes. After irradiation, the samples were diluted with water and the absorbance was measured at 444 nm. Acidic solutions of pigment in an excess of cystine (1:100) yielded a red precipitate, which was collected by centrifugation and dissolved in 5% (v/v) hydrochloric acid for spectrophotometric comparison to pigment reduced with ascorbic acid (1:1). Samples were prepared and measured in triplicate using Ocean Optics Flame spectrophotometer.

To assess whether free cysteine could be generated by irradiation of cystine in the absence of xanthommatin, 4,4′-DPS was used to measure the presence of free thiols in 100 mM solutions of cystine in acidified MES that were irradiated for 90 minutes, as described above, or stored in the dark. After irradiation, each sample was diluted (1:100) with a 4,4′-DPS solution (2 mM) that was previously bubbled with nitrogen for four hours to mitigate elimination of free thiols by dissolved oxygen. After 30 minutes, these samples were diluted with deionized water and their absorbance spectra was measured. This approach was also used to measure unirradiated solutions of 50 mM and 100 mM solutions of free cysteine in acidified MES as positive controls. Unreacted 4,4′-DPS provided an absorbance peak at 294 nm and detection of free thiols was marked by the emergence of an absorbance peak at 318 nm corresponding to 4-thiopyridone.

### Example 8: Preparation of Xanthommatin-Based Light Sensors

Nine-mm diameter discs of filter paper (Whatman 3) were prepared using a lever punch and they were arranged over the holes of a micropipette tip rack to facilitate uniform wetting during deposition of xanthommatin. A fraction of the synthesis reaction product corresponding to 2 mg of 3OHK was dissolved in 300 μL of 5% (v/v) acidic methanol and supplemented with 2 μL of saturated sodium nitrite in acidic methanol to ensure that the pigment was fully oxidized. Next, each punch of chromatography paper was saturated with 8 μL of the oxidized xanthommatin solution by pipetting. After waiting two minutes to allow each punch to be fully wetted by capillary action at room temperature, the pigment-loaded punches were transferred to a 60° C. gravity convection oven for five minutes where the solvent was removed by evaporation.

To crosslink xanthommatin distributed throughout the volume of each punch, the wet or dry punches were arranged in polystyrene culture dishes and each saturated with one drop of 2 mg/mL EDC in 50 mM MES buffer, pH 6.0, using a disposable transfer pipette. After dissolution of the stored xanthommatin, formation of amide bonds between free amine and carboxylic acid groups of adjacent pigment molecules caused the resulting assembly to be physically entrapped within the porous network of the surrounding paper. After 90 minutes of reaction time, the functionalized punches were washed by arranging them over laminated paper towels, then wetting each with drops of deionized water. Water was drawn though each punch by the capillary sink below, washing away uncoupled pigment, excess sodium nitrite, and the isourea byproduct of the coupling reaction. The wash process was completed four times, then the sensors were dried at 60° C. for 20 minutes and stored at 4° C. until use.

### Example 9: Fabrication of Multilayered Sensor Assemblies

Before irradiation, wet or dry sensors were treated with 9 μL of either (i) 100 mM cystine in a 1:1 (v/v) mixture of MES buffer and 1 M hydrochloric acid, or (ii) acidified MES alone to evaluate whether addition of disulfides could lead to radiation-induced formation of free thiols to enhance photoreduction of crosslinked xanthommatin. To mitigate evaporation of these solutions during irradiation, the sensors were sealed between a thin film of PET (0.002 in thick, McMaster-Carr) and either a UV-transmitting ETFE film (0.001 in thick, McMaster-Carr) or a UV-blocking polyester film (0.002 in thick, McMaster-Carr) to include or exclude wavelengths below 390 nm, respectively (FIG. 25). These layers were adhered to each other by lamination against a double-side adhesive (FLEXcon) with a 10 nm diameter hole removed by punching or laser cutting to accommodate the dimensions of each crosslinked xanthommatin-based sensor.

### Example 10: Measuring Sensor Responses to Ultraviolet Radiation

Sensors were subjected to controlled doses of UV radiation by calibrating the distance between the sensor surface and radiation source to a measured irradiance, then placing sensors beneath the source for the irradiation time required to reach a desired dose. For measurements of single UV regions, a handheld UV lamp (Analytik Jena) with selectable emission maxima of 254 nm (UVC), 302 nm (UVB), and 365 nm (UVA) was used. To perform independent assessments of 365 and 302 nm radiation, a portable UVA/B radiometer (SPER Scientific, 290-370 nm spectral range) was used to tune irradiance to 1.5 and 3.0 mW cm⁻², respectively, allowing a cumulative dose of 1 J cm⁻¹ over 667 or 333 seconds(s) of irradiation to be achieved. Similarly, a UVC radiometer (General Tools, 220-275 nm spectral range) was used to adjust the irradiance of 254 nm light to 1.5 mW cm⁻², again achieving a cumulative dose of 1 J cm⁻¹ in 667 s in the assessments of higher-energy radiation. UVC irradiance was adjusted to 1.0 mW cm⁻², with irradiation times for desired cumulative doses calculated accordingly, to construct the calibration curve of sensor responses to UVC.

### Example 11: Measuring Sensor Responses to Visible Radiation

To measure how the sensors responded to visible light alone, a UV-blocking film was incorporated on top of the multilayered sensor assembly and an arc lamp solar simulator calibrated to an irradiance of 500 W m⁻² using a solar power meter (Extech, 400-1100 nm spectral range) was used as a source of bright white light. This configuration allowed for a cumulative dose of 1 J cm⁻² every 20 s in initial irradiation experiments and was maintained to calibrate sensor responses to increasing doses of visible light.

### Example 12: Measuring Sensor Responses to Erythemally Weighted UV Radiation

The approximate value of UV_{Ery} can be calculated from the forecasted UV index for a given area according to the following equation:

$$UV Index = 0.4 \times {UV}_{Ery} \qquad ( Equation 1 )$$

where the units of UV_{Ery} are W m⁻². Experiments were only conducted on clear days where the sun was not visually obstructed by cloud coverage. Hourly UV index values were retrieved from the United States Environmental Protection Agency website. Sensors packaged in UV-transmitting or UV-blocking laminated assemblies were irradiated to independently assess their responses to full solar radiation (i.e., UV, visible, and IR) and the non-UV contributions (i.e., visible and IR radiation only) of solar radiation in parallel. To assess the effects of sunscreen films applied over the sensors, thin coatings of mineral (22% zinc oxide, SPF 50) or chemical (3% avobenzone, 10% homosalate, 5% octisalate, 10% octocrylene, SPF 50) sunscreens were applied to UV-transmitting sensor assemblies using a cotton swab. These devices were briefly irradiated outdoors on a clear, sunny day until the uncoated control sensors appeared visibly red, and then the sunscreen films were wiped away before imaging the devices for analysis.

### Example 13: Quantitative Analysis of Sensor Chromaticity

After each irradiation experiment, high-resolution images (600 dpi) of the sensors were obtained using a flatbed photo scanner (Epson Perfection V39) and the chromaticity of each sensor was measured using ImageJ. To represent the color shift that the sensors displayed in response to irradiation, the “b” chromaticity value of the CIELab color space, in which L represents lightness and ranges from 0 (black) to 100 (white), “a” represents chromaticity spanning green (negative values) to red (positive values), and “b” represents chromaticity spanning blue (negative values) to yellow (positive values) were used. Measured values of “b” showed the greatest sensitivity to the visible color change observed upon photoreduction of crosslinked xanthommatin in the sensors, decreasing with increasing doses of radiation and the emergence of red color. These dimensionless values were transformed by subtracting them from an arbitrary normalization factor of 100 to communicate that the sensors become redder, and less yellow, with increasing cumulative doses of radiation.

### Example 14: Fabrication of Pressure-Activated Microfluidic Devices

The base layer of the microfluidic system was a PET film (0.002 in thickness) that can be backed with adhesive to facilitate the use of the sensor as a mountable or wearable device. To create a microfluidic channel for delivering liquid to the dry sensor, a serpentine channel was patterned in a PET film (0.010 in thickness) backed on both sides with a permanent, water-resistant adhesive (FLEXcon) using a CO₂ laser system (Universal Laser). This film was laminated against the base layer and covered with a third PET layer (0.002 in thickness) containing three holes: an outlet orifice at the end of the channel concentric with the paper sensor, as well as fill and vent ports to facilitate loading of the reservoir and channel by pipetting. Upon lamination, the adhesive backing of the layer was sealed against the surface of the adjacent films to create a closed microfluidic channel. The next layer, attached to the microfluidic channel assembly using double-sided adhesive, contained a round cutout to accommodate the thickness of the paper sensor and laser-cut features to provide access to the fill and vent ports. After placing the xanthommatin-based sensor over the central channel outlet within the circular recess of the spacer layer, a UV-transmitting layer of ETFE (0.001 in thickness) patterned with fill and vent ports was adhered to the top of the device, capturing the paper-based sensor within the multilayered, laminated assembly. To ensure alignment of patterned features in each layer of the devices, alignment holes were laser-cut in each plastic film and devices were assembled layer-by-layer on stainless steel alignment pins ( 1/16 in diameter). After fabricating each microfluidic device, the fluid reservoir was filled by pipetting directly into the fill port through the ETFE layer and then covered the fill and vent ports using a small oval-shaped tab of low-tack adhesive (FLEXcon) backed with PET (0.002 in thickness).

### Example 15: Characterization of Microfluidic Devices

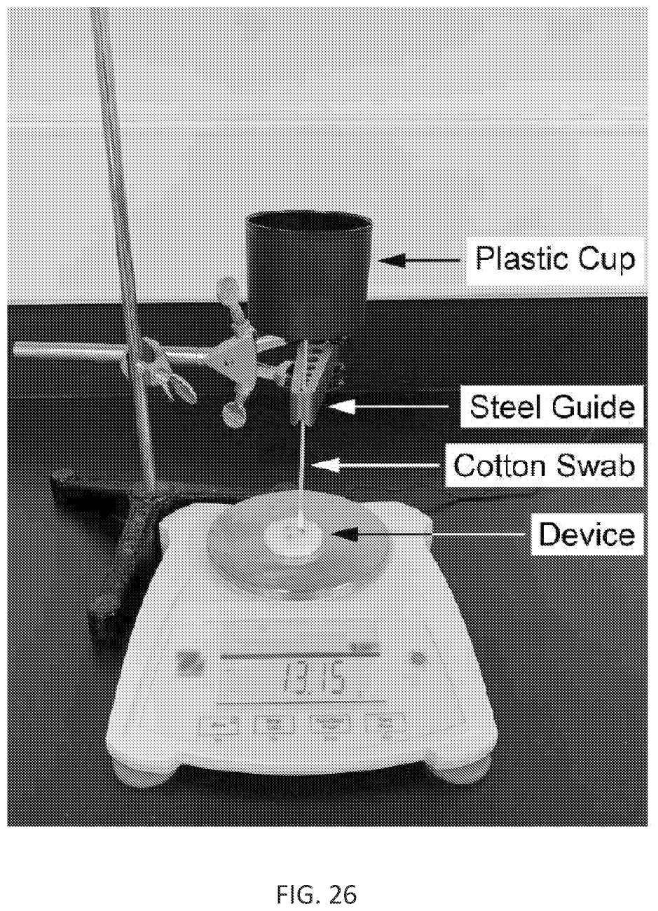

To measure the amount of force required to activate the pressure-sensitive microfluidic devices, only the microfluidic channel portion of the full device architecture (i.e., the base, channel, and channel outlet layers) was prepared to simplify visualization of the fluid front during the application of pressure to the channel reservoir. After filling the channel of the device with a predetermined volume of erioglaucine solution (25 mM), the fill port of the channel was sealed with a small piece of high-tack adhesive (FLEXcon) and the device was placed on a laboratory balance. Next, an apparatus consisting of a plastic cup fastened to the top of a cotton swab was placed onto the device. The cotton-tipped end of the swab was placed on the channel reservoir of the device, and the shaft of the cotton swab was loosely held normal to the surface of the balance using a steel guide attached to a laboratory ring stand (FIG. 26). Small steel washers, about 1 g each, were iteratively added to the plastic cup at the top of the cotton swab until the fluid front entered the channel outlet. The total mass required to move the fluid front into the channel outlet was converted to the reported activation force. All replicate measurements were performed in the same channel assembly to avoid inconsistencies in channel dimensions across replicate devices.

### Example 16: Computational Methods

DFT calculations were performed using the ORCA 4.2.1 quantum chemistry program package. PBEh-3c was used as the DFT functional together with the def2-mSVP double-zeta basis set. PBEh-3c is a reparameterized version of PBE0 (with 42% HF exchange) that includes dispersion correction (via D3), basis set superposition (via gCP), and other basis set incompleteness effects. In the framework of conceptual DFT, the global chemical hardness (n) is formally defined as the second derivative of the energy with respect to the number of electrons at a fixed external potential. In a practical way, η was calculated as the difference between the ionization energy (I) and the electron affinity (A). VMD was used for the visualization of molecular orbitals.

### REFERENCES

1 Birch-Machin, M. A., E. V. Russell, and J. A. Latimer, Mitochondrial DNA damage as a biomarker for ultraviolet radiation exposure and oxidative stress. British Journal of Dermatology, 2013. 169: p. 9-14.
2. Agar, N. S., et al., The basal layer in human squamous tumors harbors more UVA than UVB fingerprint mutations: A role for UVA in human skin carcinogenesis. Proceedings of the National Academy of Sciences of the United States of America, 2004. 101 (14): p. 4954-4959.
3. Chen, L., J. Y. Hu, and S. Q. Wang, The role of antioxidants in photoprotection: A critical review. Journal of the American Academy of Dermatology, 2012. 67 (5): p. 1013-1024.
4. Herrmann, G., et al., UVA irradiation stimulates the synthesis of various matrix-metalloproteinases (MMPs) in cultured human fibroblasts. Experimental Dermatology, 1993. 2(2): p. 92-97.
5. Liebel, F., et al., Irradiation of Skin with Visible Light Induces Reactive Oxygen Species and Matrix-Degrading Enzymes. Journal of Investigative Dermatology, 2012. 132 (7): p. 1901-1907.
6. Hudson, L., et al., Individual and combined effects of the infrared, visible, and ultraviolet light components of solar radiation on damage biomarkers in human skin cells. Faseb Journal, 2020. 34 (3): p. 3874-3883.
7. Kimeswenger, S., et al., Infrared A radiation promotes survival of human melanocytes carrying ultraviolet radiation-induced DNA damage. Experimental Dermatology, 2016. 25(6): p. 447-452.
8. Cejkova, J., et al., UV rays, the prooxidant/antioxidant imbalance in the cornea and oxidative eye damage. Physiological Research, 2004. 53 (1): p. 1-10.
9. Behar-Cohen, F., et al., Ultraviolet damage to the eye revisited: eye-sun protection factor (E-SPF), a new ultraviolet protection label for eyewear. Clinical ophthalmology (Auckland, N. Z.), 2014. 8: p. 87-104.
10. Sachdev, N. H., et al., Matrix metalloproteinases and tissue inhibitors of matrix metalloproteinases in the human lens: Implications for cortical cataract formation. Investigative Ophthalmology & Visual Science, 2004. 45 (11): p. 4075-4082.
11. Young, R. W., SOLAR-RADIATION AND AGE-RELATED MACULAR DEGENERATION. Survey of Ophthalmology, 1988. 32 (4): p. 252-269.
12. Taylor, H. R., THE BIOLOGICAL EFFECTS OF UV-B ON THE EYE.

Photochemistry and Photobiology, 1989. 50 (4): p. 489-492.
13. Deng, Y., et al., Effect of Protective Measures on Eye Exposure to Solar Ultraviolet Radiation. Photochemistry and Photobiology, 2021. 97 (1): p. 205-212.
14. Backes, C., et al., Sun exposure to the eyes: predicted UV protection effectiveness of various sunglasses. Journal of Exposure Science and Environmental Epidemiology, 2019. 29 (6): p. 753-764.
15. Iannacone, M. R., M. C. B. Hughes, and A. C. Green, Effects of sunscreen on skin cancer and photoaging. Photodermatology Photoimmunology & Photomedicine, 2014. 30 (2-3): p. 55-61.
16. Arthey, S. and V. A. Clarke, SUNTANNING AND SUN PROTECTION-A REVIEW OF THE PSYCHOLOGICAL LITERATURE. Social Science & Medicine, 1995. 40 (2): p. 265-274.
17. Radespiel-Troger, M., et al., Outdoor work and skin cancer incidence: a registry-based study in Bavaria. International Archives of Occupational and Environmental Health, 2009. 82 (3): p. 357-363.
18. Martin, C. A., et al., A bioinspired, photostable UV-filter that protects mammalian cells against UV-induced cellular damage. Chemical Communications, 2019. 55 (80): p. 12036-12039.
19. Heckman, C. J., K. Liang, and M. Riley, Awareness, understanding, use, and impact of the UV index: A systematic review of over two decades of international research. Preventive Medicine, 2019. 123: p. 71-83.
20. Norval, M., et al., The human health effects of ozone depletion and interactions with climate change. Photochemical & Photobiological Sciences, 2011. 10 (2): p. 199-225.
21. Diffey, B., Climate change, ozone depletion and the impact on ultraviolet exposure of human skin. Physics in Medicine and Biology, 2004. 49 (1): p. R1-R11.
22. Huang, X. Y. and A. N. Chalmers, Review of Wearable and Portable Sensors for Monitoring Personal Solar UV Exposure. Annals of Biomedical Engineering, 2021. 49 (3): p. 964-978.
23. Webb, A. R., et al., Know Your Standard: Clarifying the CIE Erythema Action Spectrum. Photochemistry and Photobiology, 2011. 87 (2): p. 483-486.
24. Mckenzie, R., D. Smale, and M. Kotkamp, Relationship between UVB and erythemally weighted radiation. Photochemical & Photobiological Sciences, 2004. 3 (3): p. 252-256.
25. Fitzpatrick, T. B., THE VALIDITY AND PRACTICALITY OF SUN-REACTIVE SKIN TYPE-I THROUGH TYPE-VI. Archives of Dermatology, 1988. 124 (6): p. 869-871.
26. Sayre, R. M., et al., SKIN TYPE, MINIMAL ERYTHEMA DOSE (MED), AND SUNLIGHT ACCLIMATIZATION. Journal of the American Academy of Dermatology, 1981. 5 (4): p. 439-443.
27. Diffey, B. L., et al., The standard erythema dose: a new photobiological concept. Photodermatology Photoimmunology & Photomedicine, 1997. 13 (1-2): p. 64-66.
28. Wang, J. X., et al., A Wearable Colorimetric Dosimeter to Monitor Sunlight Exposure. Advanced Materials Technologies, 2018. 3 (6): p. 8.
29. Kwon, K., et al., Miniaturized, light-adaptive, wireless dosimeters autonomously monitor exposure to electromagnetic radiation. Science Advances, 2019. 5 (12): p. 9.
30. AbdelFattah, A. A., M. ElKelany, and F. AbdelRehim, Development of a radiation-sensitive indicator. Radiation Physics and Chemistry, 1996. 48 (4): p. 497-503.
31. Mills, A., et al., Flagging up sunburn: a printable, multicomponent, UV-indicator that warns of the approach of erythema. Chemical Communications, 2009 (11): p. 1345-1346.
32. Mills, A., M. McFarlane, and S. Schneider, A viologen-based UV indicator and dosimeter. Analytical and Bioanalytical Chemistry, 2006. 386 (2): p. 299-305.
33. Ebbesen, T. W., G. Levey, and L. K. Patterson, PHOTO-REDUCTION OF METHYL VIOLOGEN IN AQUEOUS NEUTRAL SOLUTION WITHOUT ADDITIVES. Nature, 1982. 298 (5874): p. 545-548.
34. Zou, W. Y., et al., Skin color-specific and spectrally-selective naked-eye dosimetry of UVA, B and C radiations. Nature Communications, 2018. 9.
35. Hacker, E., et al., UV detection stickers can assist people to reapply sunscreen. Preventive Medicine, 2019. 124: p. 67-74.
36. Heo, S. Y., et al., Wireless, battery-free, flexible, miniaturized dosimeters monitor exposure to solar radiation and to light for phototherapy. Science Translational Medicine, 2018. 10 (470): p. 12.
37. Williams, T. L., et al., Contributions of Phenoxazone-Based Pigments to the Structure and Function of Nanostructured Granules in Squid Chromatophores. Langmuir, 2016. 32 (15): p. 3754-3759.
38. Wiley, K. and H. S. Forrest, TERMINAL SYNTHESIS OF XANTHOMMATIN IN DROSOPHILA-MELANOGASTER.4. ENZYMATIC AND NON-ENZYMATIC CATALYSIS. Biochemical Genetics, 1981. 19 (11-1): p. 1211-1221.
39. Futahashi, R., et al., Redox alters yellow dragonflies into red. Proceedings of the National Academy of Sciences of the United States of America, 2012. 109 (31): p. 12626-12631.
40. Denys, C. J., OMMOCHROME PIGMENTS IN THE EYES OF EUPHAUSIA-SUPERBA (CRUSTACEA, EUPHAUSIACEA). Polar Biology, 1982. 1 (2): p. 69-76.
41. Bolognese, A., R. Liberatore, and G. Scherillo, PHOTOCHEMISTRY OF OMMOCHROMES AND RELATED-COMPOUNDS. Journal of Heterocyclic Chemistry, 1988. 25 (3): p. 979-983.
42. Figon, F. and J. Casas, Ommochromes in invertebrates: biochemistry and cell biology. Biological Reviews, 2019. 94 (1): p. 156-183.
43. Falcone, L. M. and P. C. Zeidler-Erdely, Skin cancer and welding. Clinical and Experimental Dermatology, 2019. 44 (2): p. 130-134.
44. Cheigh, C. I., et al., Comparison of intense pulsed light- and ultraviolet (UVC)-induced cell damage in Listeria monocytogenes and Escherichia coli 0157: H7. Food Control, 2012. 25 (2): p. 654-659.
45. Osanai-Futahashi, M., et al., Positional cloning of a Bombyx pink-eyed white egg locus reveals the major role of cardinal in ommochrome synthesis. Heredity, 2016. 116 (2): p. 135-145.
46. Kumar, A., et al., Xanthommatin-Based Electrochromic Displays Inspired by Nature. Acs Applied Materials & Interfaces, 2018. 10 (49): p. 43177-43183.
47. Zhao, Z. C.; Poojary, M. M.; Skibsted, L. H.; Lund, M. N. Cleavage of Disulfide Bonds in Cystine by UV-B Illumination Mediated by Tryptophan or Tyrosine as Photosensitizers. J. Agric. Food Chem. 2020, 68, 6900-6909.
48. Ryall, R. L.; Howells, A. J. Ommochrome biosynthetic pathway of Drosophila melanogaster: Variations in levels of enzyme activities and intermediates during adult development. Insect Biochem. 1974, 4, 47-61.
49. Hansen, R. E.; Ostergaard, H.; Norgaard, P.; Winther, J. R. Quantification of protein thiols and dithiols in the picomolar range using sodium borohydride and 4,4′-dithiodipyridine. Anal. Biochem. 2007, 363, 77-82.
50. Riccardi, C. M.; Mistri, D.; Hart, O.; Anuganti, M.; Lin, Y.; Kasi, R. M.; Kumar, C. V. Covalent interlocking of glucose oxidase and peroxidase in the voids of paper: enzyme-polymer “spider webs”. Chem. Commun. 2016, 52, 2593-2596.
51. DeChiara, N. S.; Wilson, D. J.; Mace, C. R. An Open Software Platform for the Automated Design of Paper-Based Microfluidic Devices. Sci. Rep. 2017, 7, No. 16224.
52. Martinez, A. W.; Phillips, S. T.; Butte, M. J.; Whitesides, G. M. Patterned paper as a platform for inexpensive, low-volume, portable bioassays. Angew. Chem., Int. Ed. 2007, 46, 1318-1320.
53. Kowalski, W. Ultraviolet Germicidal Irradiation Handbook.; Springer: New York, 2009; pp 1-501.
54. Walker, C. M.; Ko, G. Effect of ultraviolet germicidal irradiation on viral aerosols. Environ. Sci. Technol. 2007, 41, 5460-5465.
55. Islam, M. S.; Patras, A.; Pokharel, B.; Wu, Y.; Vergne, M. J.; Shade, L.; Xiao, H.; Sasges, M. UV-C irradiation as an alternative disinfection technique: Study of its effect on polyphenols and antioxidant activity of apple juice. Innovative Food Sci. Emerg. Technol. 2016, 34, 344-351.
56. Cantos, E.; Espin, J. C.; Fernandez, M. J.; Oliva, J.; Tomas-Barberan, F. A. Postharvest UV-C-irradiated grapes as a potential source for producing stilbene-enriched red wines. J. Agric. Food Chem. 2003, 51, 1208-1214.
57. Boyce, J. M.; Donskey, C. J. Understanding ultraviolet light surface decontamination in hospital rooms: A primer. Infect. Control Hosp. Epidemiol. 2019, 40, 1030-1035.
58. Masse, V.; Hartley, M. J.; Edmond, M. B.; Diekema, D. J. Comparing and optimizing ultraviolet germicidal irradiation systems use for patient room terminal disinfection: an exploratory study using radiometry and commercial test cards. Antimicrob. Resist. Infect. Control 2018, 7, No. 7.
59. Hong, S.; Gu, Y.; Seo, J. K.; Wang, J.; Liu, P.; Meng, Y. S.; Xu, S.; Chen, R. K. Wearable thermoelectrics for personalized thermoregulation. Sci. Adv. 2019, 5, No. eaaw0536.
60. Lindblad, M.; Tano, E.; Lindahl, C.; Huss, F. Ultraviolet-C decontamination of a hospital room: Amount of UV light needed. Burns 2020, 46, 842-849.
61. Lemons, A. R.; McClelland, T. L.; Martin, S. B.; Lindsley, W. G.; Green, B. J. Inactivation of the multi-drug-resistant pathogen Candida auris using ultraviolet germicidal irradiation. J. Hosp. Infect. 2020, 105, 495-501.
62. Quek, P. H.; Hu, J. Y. Indicators for photoreactivation and dark repair studies following ultraviolet disinfection. J. Ind. Microbiol. Biotechnol. 2008, 35, 533-541.
63. Biasin, M.; Bianco, A.; Pareschi, G.; Cavalleri, A.; Cavatorta, C.; Fenizia, C.; Galli, P.; Lessio, L.; Lualdi, M.; Tombetti, E.; Ambrosi, A.; Redaelli, E. M. A.; Saulle, I.; Trabattoni, D.; Zanutta, A.; Clerici, M. UV-C irradiation is highly effective in inactivating SARS-CoV-2 replication. Sci. Rep. 2021, 11, No. 6260.
64. Fernandes, S. C.; Walz, J. A.; Wilson, D. J.; Brooks, J. C.; Mace, C. R. Beyond Wicking: Expanding the Role of Patterned Paper as the Foundation for an Analytical Platform. Anal. Chem. 2017, 89, 5654-5664.
65. Sierra, T.; Jang, I.; Noviana, E.; Crevillen, A. G.; Escarpa, A.; Henry, C. S. Pump-Free Microfluidic Device for the Electrochemical Detection of alpha (1)-Acid Glycoprotein. ACS Sens. 2021, 6, 2998-3005.
66. Channon, R. B.; Nguyen, M. P.; Scorzelli, A. G.; Henry, E. M.; Volckens, J.; Dandy, D. S.; Henry, C. S. Rapid flow in multilayer microfluidic paper-based analytical devices. Lab Chip 2018, 18, 793-802.
67. Islam, M. S., et al., UV-C irradiation as an alternative disinfection technique: Study of its effect on polyphenols and antioxidant activity of apple juice. Innovative Food Science & Emerging Technologies, 2016. 34: p. 344-351.
68. Cantos, E., et al., Postharvest UV-C-irradiated grapes as a potential source for producing stilbene-enriched red wines. Journal of Agricultural and Food Chemistry, 2003. 51 (5): p. 1208-1214.

69 Boyce, J. M. and C. J. Donskey, Understanding ultraviolet light surface decontamination in hospital rooms: A primer. Infection Control and Hospital Epidemiology, 2019. 40 (9): p. 1030-1035.
70. Butenandt, A., U. Schiedt, and E. Biekert, Über Ommochrome, III. Mitteilung: Synthese des Xanthommatins. Justus Liebigs Annalen der Chemie, 1954. 588 (2): p. 106-116.
71. Figon, F., et al., Uncyclized xanthommatin is a key ommochrome intermediate in invertebrate coloration. Insect Biochemistry and Molecular Biology, 2020. 124: p. 16.
72. Hori, M. and L. M. Riddiford, ISOLATION OF OMMOCHROMES AND 3-HYDROXYKYNURENINE FROM THE TOBACCO HORNWORM, MANDUCA-SEXTA. Insect Biochemistry, 1981. 11 (5): p. 507-513.
73 UV Index. Aug. 11, 2021]; Available from: https://www.epa.gov/sunsafety/uv-index-1.
74. NIH ImageJ. Available from: https://imagej.nih.gov/ij/index.html.
75. Neese, F.; Wennmohs, F.; Becker, U.; Riplinger, C. The ORCA quantum chemistry program package. J. Chem. Phys. 2020, 152, No. 224108.
76. Grimme, S.; Brandenburg, J. G.; Bannwarth, C.; Hansen, A. Consistent structures and interactions by density functional theory with small atomic orbital basis sets. J. Chem. Phys. 2015, 143, No. 054107.
77. Geerlings, P.; De Proft, F.; Langenaeker, W. Conceptual density functional theory. Chem. Rev. 2003, 103, 1793-1873.
78. Parr, R. G.; Pearson, R. G. Absolute Hardness-Companion Parameter To Absolute Electronegativity. J. Am. Chem. Soc. 1983, 105, 7512-7516.
79. Cárdenas, C.; Ayers, P.; De Proft, F.; Tozer, D. J.; Geerlings, P. Should negative electron affinities be used for evaluating the chemical hardness? Phys. Chem. Chem. Phys. 2011, 13, 2285-2293.
80. Humphrey, W.; Dalke, A.; Schulten, K. VMD: Visual molecular dynamics. J. Mol. Graphics 1996, 14, 33-38.

The teachings of all patents, published applications, and references cited herein are incorporated by reference in their entirety.

While example embodiments have been particularly shown and described, it will be understood by those skilled in the art that various changes in form and details may be made therein without departing from the scope of the embodiments encompassed by the appended claims.

1. A sensor comprising a porous substrate or a paper substrate comprising unaggregated xanthommatin or a salt or a crosslinked derivative thereof.

2. (canceled)

3. The sensor of claim 1, wherein the xanthommatin or a salt or a crosslinked derivative thereof is unaggregated xanthommatin or a salt or a crosslinked derivative thereof, or is uniformly distributed throughout the substrate.

4. (canceled)

5. The sensor of claim 1, wherein the substrate further comprises one or more additional molecules that impart a color.

6. The sensor of claim 1, wherein the substrate comprises crosslinked xanthommatin or a salt thereof.

7. (canceled)

8. The sensor of claim 1, wherein the sensor is sealed inside a chamber, at least a portion of which is transmissive and is configured to allow light to reach the substrate or a portion thereof, the chamber is formed at least in part by a transmissive film configured to allow light to reach the substrate or a portion thereof, or the chamber is formed by a transmissive film configured to allow light to reach the substrate or a portion thereof adhered to a base.

9. (canceled)

10. (canceled)

11. The sensor of claim 1, comprising a base; a spacer; and a transmissive film adhered to the base via the spacer, wherein:
a) the transmissive film is configured to allow light to reach the substrate or a portion thereof; and
b) the substrate is sealed within the sensor, and is within the spacer.

12. The sensor of claim 11, wherein the transmissive film is UV-transparent or UV-blocking.

13. The sensor of claim 1, wherein the substrate is dry.

14. (canceled)

15. (canceled)

16. The sensor of claim 1, wherein the substrate is wet with an aqueous solution that has a pH of about 0 to about 7.

17. The sensor of claim 16, wherein the aqueous solution further comprises a disulfide compound.

18. (canceled)

19. The sensor of claim 1, wherein the sensor imparts a colorimetric output in response to solar or UVC irradiation.

20. (canceled)

21. A microfluidic device, comprising:
a) a sensor of claim 8;
b) a liquid reservoir; and
c) a channel,
wherein the liquid reservoir is in fluid communication with the substrate via the channel, whereby application of force to the liquid reservoir drives liquid contained therein through the channel to the substrate.

22. A microfluidic device, comprising: a base layer; a second layer adhered to the base layer, the second layer comprising the liquid reservoir and the channel; a third layer adhered to the second layer, the third layer comprising an outlet in contact with the channel; a spacer adhered to the third layer; a sensor of claim 1 in fluid communication with the outlet; and a transmissive layer, wherein:
a) the transmissive layer is configured to allow light to reach the substrate or a portion thereof; and
b) the substrate is sealed within the device and is within the spacer.

23. The microfluidic device of claim 22, wherein the outlet layer further comprises a fill port or a vent port, or both in fluid communication with the liquid reservoir.

24. The microfluidic device of claim 21, wherein the substrate is wet.

25. (canceled)

26. The microfluidic device of claim 21, wherein the reservoir comprises an aqueous solution.

27. (canceled)

28. (canceled)

29. (canceled)

30. A method of making a sensor of claim 1, the method comprising incubating the substrate with a first mixture comprising xanthommatin or a salt thereof in a first solvent, thereby distributing the xanthommatin or a salt thereof throughout the substrate.

31. The method of claim 30, wherein the first mixture has a pH of about 0 to about 7.

32. (canceled)

33. The method of claim 30, further comprising crosslinking the xanthommatin or a salt thereof, thereby forming one or more crosslinked derivatives of xanthommatin or a salt thereof distributed throughout the substrate; washing the substrate to remove xanthommatin or a salt thereof not distributed throughout the substrate or uncrosslinked xanthommatin or a salt thereof or both; drying the substrate comprising xanthommatin or a salt thereof, or the substrate comprising crosslinked xanthommatin or a salt thereof, or both; or any combination thereof.

34. (canceled)

35. (canceled)

36. A solar radiometer comprising the sensor of claim 1.

37. (canceled)

38. (canceled)

39. A UVC radiation detector comprising the sensor of claim 1.

40. (canceled)

41. (canceled)
